(19) United States
(12) Patent Application Publication
(10) Pub. No.: US 2010/0024742 A1
(43) Pub. Date: Feb. 4, 2010

(54) LEASH SECURING ASSEMBLY

(76) Inventors: Jason Honeycutt, Charlotte, NC (US); Daniel Lee Bizzell, Davidson, NC (US); Carole Ruffin, Charlotte, NC (US); Ian Kovacevich, Charlotte, NC (US)

Correspondence Address: TILLMAN WRIGHT, PLLC, P.O. BOX 49309, CHARLOTTE, NC, 28277-0076, US

(21) Appl. No.: 12/510,214

(22) Filed: Jul. 27, 2009

Related U.S. Application Data
(60) Provisional application No. 61/083,648, filed on Jul. 25, 2008.
(60) Provisional application No. 61/083,666, filed on Jul. 25, 2008.

(51) Int. Cl. A01K 27/00; A01K 29/00

(52) U.S. Cl. 119/795; 119/857

(57) ABSTRACT

A leash securing assembly includes a cuff having interior and exterior surfaces, the interior surface comprising one or more fastening components configured for securement with one or more fastening components of the exterior surface; a webbing loop secured to the cuff; a shock cord comprising an elastic member having two ends, two fasteners, two connecting members, each connecting member connecting one of the ends of the elastic member to a respective one of the two fasteners, and an outer sheath enclosing the elastic member; wherein one of the two fasteners of the shock cord is coupled to the webbing loop.

### CROSS-REFERENCE TO RELATED APPLICATION

The present application is a U.S. nonprovisional patent application of, and claims priority under 35 U.S.C. §119(e) to, each of:

(a) U.S. provisional patent application serial number 61/083,648, filed Jul. 25, 2008; and

(b) U.S. provisional patent application serial number 61/083,666, filed Jul. 25, 2008.

The entire disclosure of each provisional application is hereby incorporated herein by reference, including the copy of the '648 application attached hereto as Appendix Z.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to a hands free animal leash securing assembly.

Animal leashes are well known in the prior art; however, traditional animal leashes require a user to hold or grasp one end of the leash. U.S. Pat. No. 6,095,093, hereby incorporated herein by reference, discloses an animal leash securing assembly which may be worn about an arm of a user, thereby allowing the user to retain control over an animal, while still providing a hands free environment for the user. It is believed that one or more modifications or improvements contained herein represent patentable subject matter.

Although the '093 patent meets one or more needs relating to animal leash assemblies, a need still exists for improvement. This, and other needs, are addressed by one or more aspects of the present invention.

### SUMMARY OF THE INVENTION

The present invention includes many aspects and features. Moreover, while many aspects and features relate to, and are described in, the context of animal leash assemblies, the present invention is not limited to use only in animal leash assemblies, as will become apparent from the following summaries and detailed descriptions of aspects, features, and one or more embodiments of the present invention.

Accordingly, one aspect of the present invention relates to a leash securing assembly. The leash securing assembly comprises a cuff having interior and exterior surfaces, the interior surface comprising one or more fastening components configured for securement with one or more fastening components of the exterior surface; a webbing loop secured to the cuff; a shock cord comprising an elastic member having two ends, two fasteners, two connecting members, each connecting member connecting one of the ends of the elastic member to a respective one of the two fasteners, and an outer sheath enclosing the elastic member; wherein one of the two fasteners of the shock cord is coupled to the webbing loop.

In a feature of this aspect of the invention, the one of the two fasteners of the shock cord is removably coupled to the webbing loop.

In a feature of this aspect of the invention, the one of the two fasteners of the shock cord is permanently coupled to the webbing loop.

In a feature of this aspect of the invention, the webbing loop is secured to the cuff via stitching.

In a feature of this aspect of the invention, one of the fasteners comprises a carabineer.

In a feature of this aspect of the invention, each of the fasteners comprises a carabineer.

In a feature of this aspect of the invention, the one or more fastening components of the interior surface comprise loop fastening components and the one or more fastening components of the exterior surface comprise hook fastening components configured to mate with the loop fastening components.

Another aspect of the present invention relates to a leash securing assembly. The leash securing assembly includes a retention device having an eye defined therethrough. The leash securing assembly further includes a band member having first and second ends, the first end being secured to the retention device and the second end being adapted to be threaded through the eye and then secured to a middle portion of the band member. The leash securing assembly additionally includes a ring member coupled to the retention device and a coupling member coupled to the ring member. The band member and the retention device are adapted to together define a generally elliptical loop.

In a feature of this aspect of the invention, the retention device comprises a backing member having a retention member secured to it.

In a feature of this aspect of the invention, the eye is defined through the backing member.

In a feature of this aspect of the invention, the eye is defined through the retention member.

In a feature of this aspect of the invention, the eye is defined through the backing member and the retention member.

In a feature of this aspect of the invention, the first end of the band member is secured to the retention member.

In a feature of this aspect of the invention, the first end of the band member is releasably secured to the retention member.

In a feature of this aspect of the invention, the first end of the band member is releasably secured to the retention member by a hook and loop fastener.

In a feature of this aspect of the invention, the first end of the band member is secured to the backing member.

In a feature of this aspect of the invention, the first end of the band member is releasably secured to the backing member.

In a feature of this aspect of the invention, the first end of the band member is releasably secured to the retention member by a hook and loop fastener.

In a feature of this aspect of the invention, the ring member encircles the retention member such that it may slide freely along the retention member.

In a feature of this aspect of the invention, the backing member and the band member together define the generally elliptical loop.

In a feature of this aspect of the invention, the band member is releasably secured to the retention device.

In a feature of this aspect of the invention, the band member is releasably secured to the retention device by a hook and loop fastener.

In a feature of this aspect of the invention, the second end of the band member is releasably secured to the middle portion of the band member.

In a feature of this aspect of the invention, the second end of the band member is releasably secured to the middle portion of the band member by a hook and loop fastener.

In a feature of this aspect of the invention, the generally elliptical loop is adapted to receive an arm of a user, and the leash securing assembly is adapted to be secured about an upper portion of the arm of the user.

In a feature of this aspect of the invention, the coupling device includes an elastic member having two ends and coupling members secured to each end.

In a feature of this aspect of the invention, a portion of each of the coupling members is embedded within the elastic member.

In a feature of this aspect of the invention, the portion of each of the coupling members is molded within the elastic member.

In a feature of this aspect of the invention, the coupling members comprise carabineers.

In a feature of this aspect of the invention, the elastic member is injection molded.

In a feature of this aspect of the invention, the elastic member is an elastomer.

In a feature of this aspect of the invention, the elastic member is configured to break proximate a middle portion of the elastic member when tensioned.

In a feature of this aspect of the invention, a first of the coupling members is coupled to the ring member.

In a feature of this aspect of the invention, a leash is coupled to a second of the coupling members of the coupling device.

In a feature of this aspect of the invention, the leash securing assembly is secured about an arm of a user.

A second aspect of the present invention relates to a leash securing assembly. The leash securing assembly includes a retention member having an eye defined therethrough. The leash securing assembly further includes a band member secured to the retention member, an end of the band member being threaded through the eye and then secured to a middle portion of the band member. The leash securing assembly additionally includes a ring member coupled to the retention member and a coupling member coupled to the ring member. The band member is adapted to define a generally elliptical loop.

In a feature of this aspect of the invention, the eye is further defined through a portion of the band member.

In a feature of this aspect of the invention, the band member is secured to the retention member by threading the end of the band member through the eye defined in the band member and the retention member.

In a feature of this aspect of the invention, the ring member encircles the retention member such that it may slide freely along the retention member.

In a feature of this aspect of the invention, the backing member and the band member together define the generally elliptical loop.

In a feature of this aspect of the invention, the end of the band member is releasably secured to the middle portion of the band member.

In a feature of this aspect of the invention, the end of the band member is releasably secured to the middle portion of the band member by a hook and loop fastener.

In a feature of this aspect of the invention, the generally elliptical loop is adapted to receive an arm of a user, and the leash securing assembly is adapted to be secured about an upper portion of the arm of the user.

In a feature of this aspect of the invention, the coupling device includes an elastic member having two ends and coupling members secured to each end.

In a feature of this aspect of the invention, a portion of each of the coupling members is embedded within the elastic member.

In a feature of this aspect of the invention, the portion of each of the coupling members is molded within the elastic member.

In a feature of this aspect of the invention, the coupling members comprise carabineers.

In a feature of this aspect of the invention, the elastic member is injection molded.

In a feature of this aspect of the invention, the elastic member is an elastomer.

In a feature of this aspect of the invention, the elastic member is configured to break proximate a middle portion of the elastic member when tensioned.

In a feature of this aspect of the invention, a first of the coupling members is coupled to the ring member.

In a feature of this aspect of the invention, a leash is coupled to a second of the coupling members of the coupling device.

In a feature of this aspect of the invention, the leash securing assembly is secured about an arm of a user.

A third aspect of the present invention relates to a method of using a leash securing assembly, wherein the leash securing assembly includes: a retention device having an eye defined therethrough, a band member having first and second ends, the first end being secured to the retention device and the second end being adapted to be threaded through the eye and then secured to a middle portion of the band member, a ring member coupled to the retention device, and a coupling member coupled to the ring member; and the band member and the retention device are adapted to together define a generally elliptical loop. The method includes threading the second end of the band member through the eye, such that the generally elliptical loop is defined, inserting an arm of a user into the elliptical loop and positioning the leash securing assembly about an upper portion of the arm of the user, pulling the band member through the eye, thereby reducing a circumference of the generally elliptical loop, until the leash securing assembly is tight around the upper portion of the arm, and securing the band member to itself such that the circumference of the generally elliptical loop is generally fixed.

In a feature of this aspect of the invention, the band member is secured to itself by a hook and loop fastener.

In a feature of this aspect of the invention, the method further comprises coupling a leash to the coupling member.

In a feature of this aspect of the invention, the method further comprises securing the leash to an animal.

In a feature of this aspect of the invention, the method further comprises walking.

In a feature of this aspect of the invention, the method further comprises jogging.

In a feature of this aspect of the invention, the method further comprises running.

A fourth aspect of the present invention relates to a leash securing assembly. The leash securing assembly includes an armband and a coupling device coupled to said armband. The coupling device includes an elastic member and a fastener embedded within said elastic member.

In a feature of this aspect of the invention, said elastic member is injection molded and is adapted to break proximate said middle portion when tensioned.

A fifth aspect of the present invention relates to a coupling device. The coupling device includes an elastic member and a fastener embedded within said elastic member.

In a feature of this aspect of the invention, said elastic member is injection molded and is adapted to break proximate said middle portion when tensioned.

A sixth aspect of the present invention relates to a method of breaking a coupling device. The method includes the steps of obtaining a coupling device having ends tapering to a narrower middle portion and tensioning said ends.

A seventh aspect of the present invention relates to a method of breaking a coupling device. The method includes the steps of securing an armband to an arm of a user; coupling a coupling device to said armband, said coupling device having ends tapering to a narrower middle portion, and said coupling device being adapted to break proximate said middle portion when tensioned; and causing said middle portion to be tensioned.

In a feature of this aspect of the invention, said coupling device includes an elastic member and a fastener embedded within said elastic member.

In a feature of this aspect of the invention, the step of causing said middle portion to be tensioned includes the step of coupling an animal leash to said coupling device.

In a feature of this aspect of the invention, said armband includes a retention device having an eye defined therethrough, a band member having first and second ends, said first end being secured to said retention device and said second end being adapted to be threaded through said eye and then secured to a middle portion of said band member, and a ring member coupled to said retention device, wherein said step of coupling said coupling device to said armband comprises coupling said coupling device to said ring member.

Another aspect of the present invention relates to a coupling device. The coupling device includes an elastic member and a fastener embedded within the elastic member.

In a feature of this aspect of the invention, the elastic member has two ends, the first fastener being embedded within a first of the two ends, and a second fastener being embedded within a second of the two ends.

In a feature of this aspect of the invention, the fastener is a carabineer.

In a feature of this aspect of the invention, the fastener comprises aluminum.

In a feature of this aspect of the invention, the elastic member comprises an elastomeric material.

In a feature of this aspect of the invention, the elastic member is a thermoplastic rubber.

In a feature of this aspect of the invention, the elastic member was injection molded.

A second aspect of the present invention relates to a coupling device. The coupling device includes an elastic member having a middle portion and two ends and two carabineers, one carabineer being embedded within each end. Further, the elastic member is injection molded and the elastic member is adapted to break proximate the middle portion when tensioned.

In a feature of this aspect of the invention, the elastic member comprises an elastomeric material.

In a feature of this aspect of the invention, the elastic member is a thermoplastic rubber.

In a feature of this aspect of the invention, the two carabineers are aluminum.

In a feature of this aspect of the invention, the elastic member was injection molded.

A third aspect of the present invention relates to a method of manufacturing a coupling device. The method includes the steps of providing a mold, orienting a fastener relative to the mold, and injecting a heated elastomeric substance into the mold.

In a feature of this aspect of the invention, the fastener is a carabineer.

In a feature of this aspect of the invention, the carabineer is aluminum.

In a feature of this aspect of the invention, the elastomeric substance is a thermoplastic rubber.

In a feature of this aspect of the invention, a second fastener is oriented relative to the mold prior to the injecting step.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIGS. 1A and 1B are perspective views of a leash securing assembly in accordance with a first preferred embodiment of the present invention;

FIGS. 2A and 2B are top perspective views of a leash securing assembly similar to that of FIGS. 1A and 1B;

FIG. 3 is a perspective view of the leash securing assembly of FIGS. 1A and 1B, illustrating an eye;

FIG. 4 is a perspective view of a leash securing assembly having a plurality of raised dots on a tab;

FIG. 5 is a perspective view of a leash securing assembly having a logo on a tab;

FIG. 6 is an end view of the coupling device of FIGS. 1A and 1B;

FIG. 7 is an end cross-sectional view of the coupling device of FIGS. 1A and 1B, taken along line 7-7;

FIG. 8 is a perspective view of the leash securing assembly of FIGS. 1A and 1B, shown in use;

FIGS. 9A and 9B are perspective views of a leash securing assembly in accordance with a second preferred embodiment of the present invention;

FIG. 10 is a front plan view of the leash securing assembly of FIGS. 9A and 9B;

FIG. 11 is a top perspective view of the leash securing assembly of FIGS. 9A and 9B;

FIG. 12 is a perspective view of the leash securing assembly of FIGS. 9A and 9B illustrating how a band member may be detached from a retention device;

FIG. 13 is a perspective views of a leash securing assembly in accordance with a third preferred embodiment of the present invention;

FIG. 14 is a perspective views of the cuff element of the leash securing assembly of FIG. 13 in an open configuration;

FIG. 15 is a perspective view of the cuff element of the leash securing assembly of FIG. 13 in a closed configuration;

FIG. 16 is an inside view the cuff shown in FIG. 14;

FIG. 17 is a top view of the cuff shown in FIG. 14;

FIG. 18 is an outside view of the cuff shown in FIG. 14;

FIG. 19 is a front perspective view of the shock cord element of the leash securing assembly of FIG. 13;

FIG. 20 is a side view of the shock cord shown in FIG. 19 with the bottom half shown as a cross-section;

FIG. 21 is a front cross-sectional view of the shock cord shown in FIG. 19 taken at the line 21-21;

FIGS. 22A and 22B are each a top view of a coupling device in accordance with a preferred embodiment of the present invention;

FIG. 23 is a top cross-sectional view of the coupling device of FIGS. 22A and 22B illustrating carabineers embedded within an elastic member;

FIG. 24 is a top view of the coupling device of FIGS. 22A and 22B illustrating how a hinged segment of a carabineer may be rotated about a hinge;

FIG. 25 is an environmental perspective view of the coupling device of FIGS. 22A and 22B shown coupled to an armband;

FIG. 26 is an end view of the coupling device of FIG. 25;

FIG. 27 is an end cross-sectional view of the coupling device of FIG. 25, taken along line 27-27;

FIG. 28 is a top view of the coupling device of FIGS. 22A and 22B when tensioned; and

FIG. 29 is a top view of the coupling device of FIGS. 22A and 22B after breaking proximate a middle portion of an elastic member of the coupling device.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

### Leash Securing Assembly

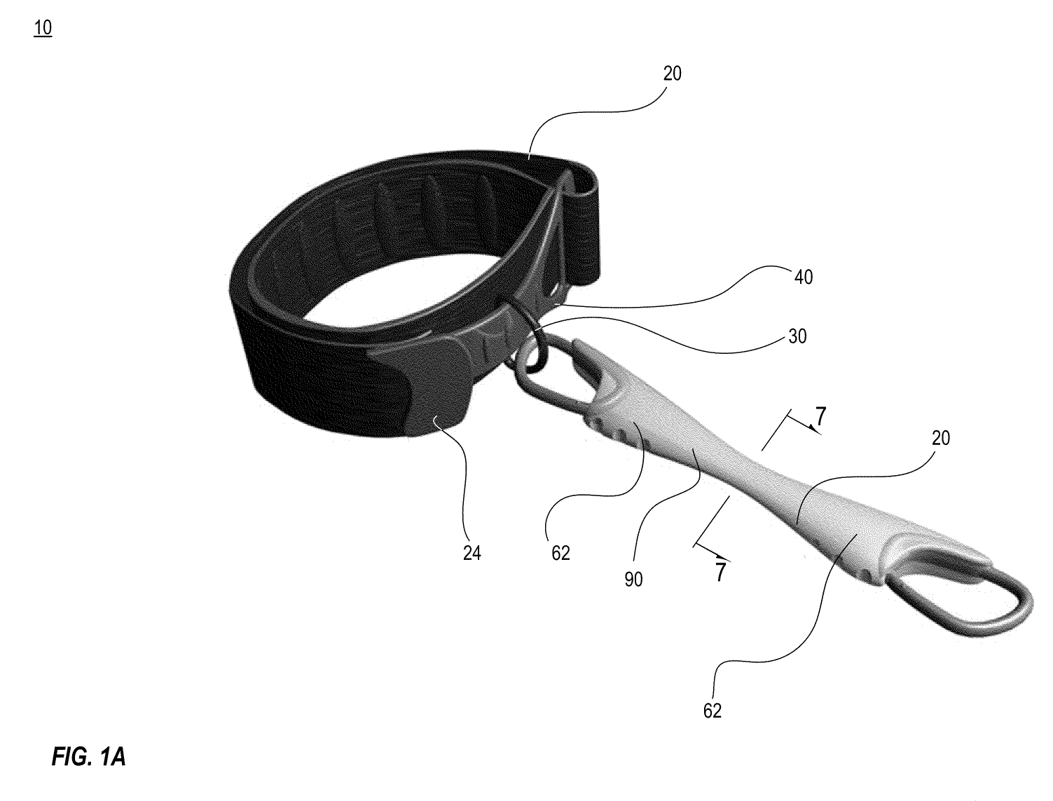

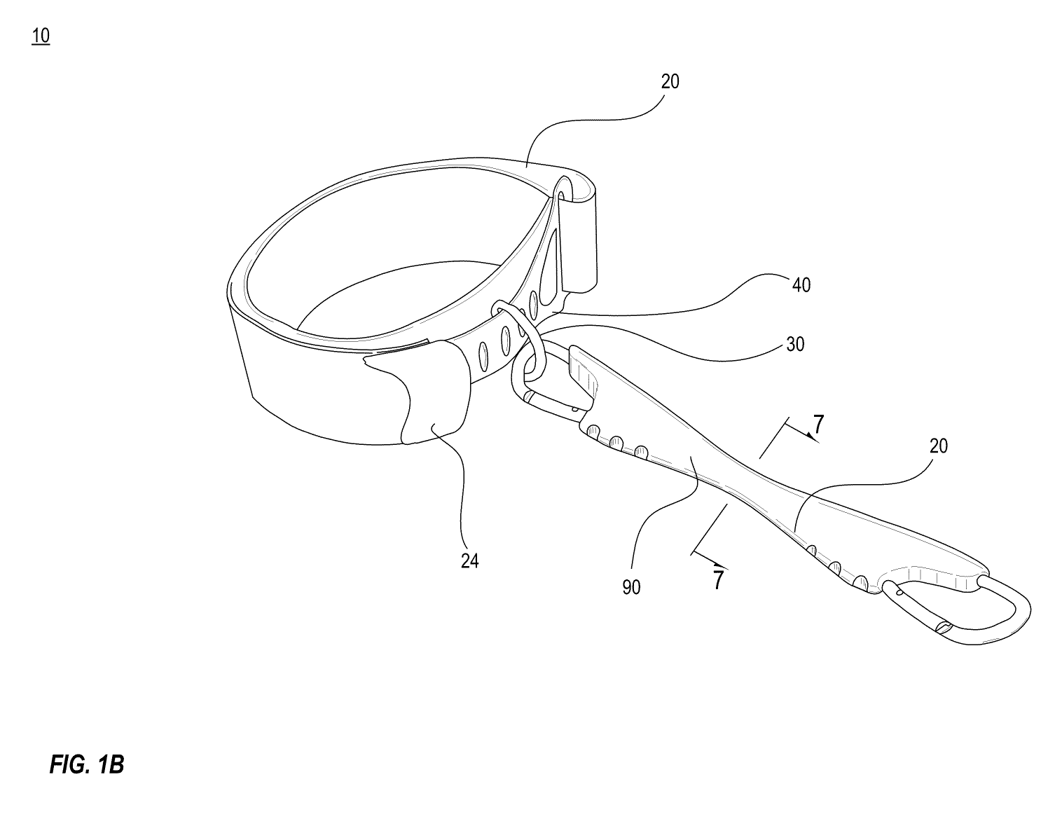

FIGS. 1A and 1B are perspective views of a leash securing assembly 10 in accordance with a first preferred embodiment of the present invention. The leash securing assembly 10 includes a band member 20, a ring member 30, a retention member 40, and a coupling device 90.

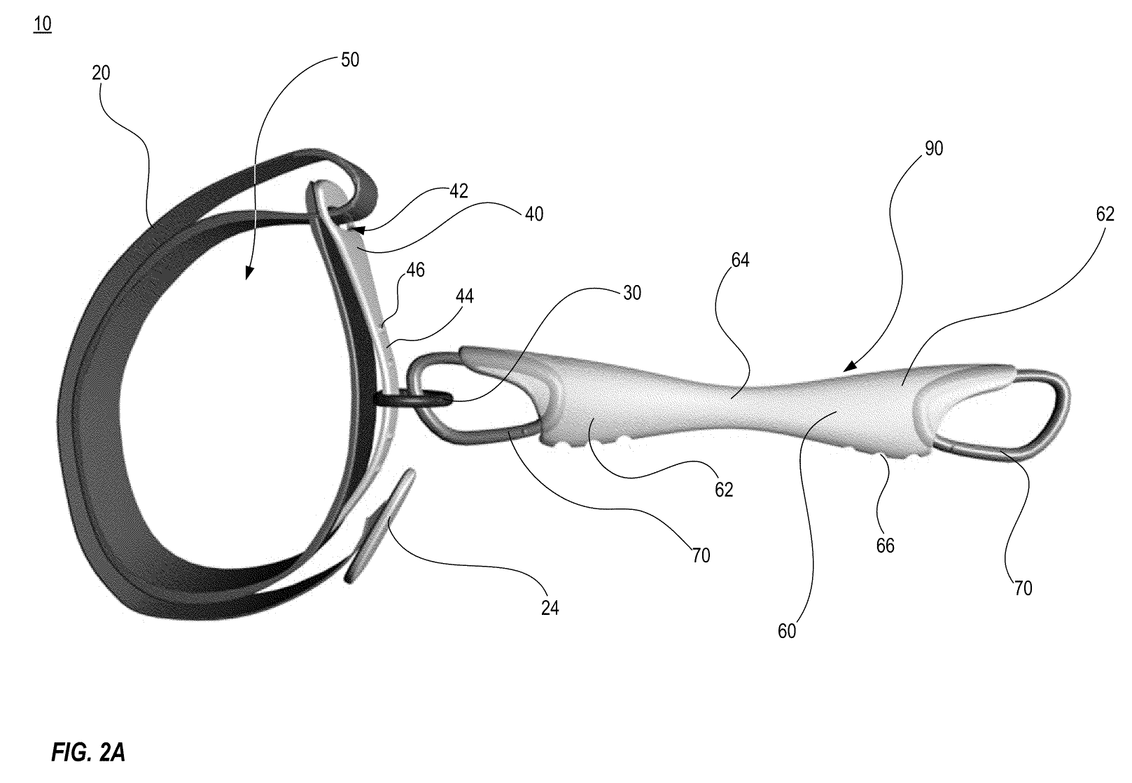

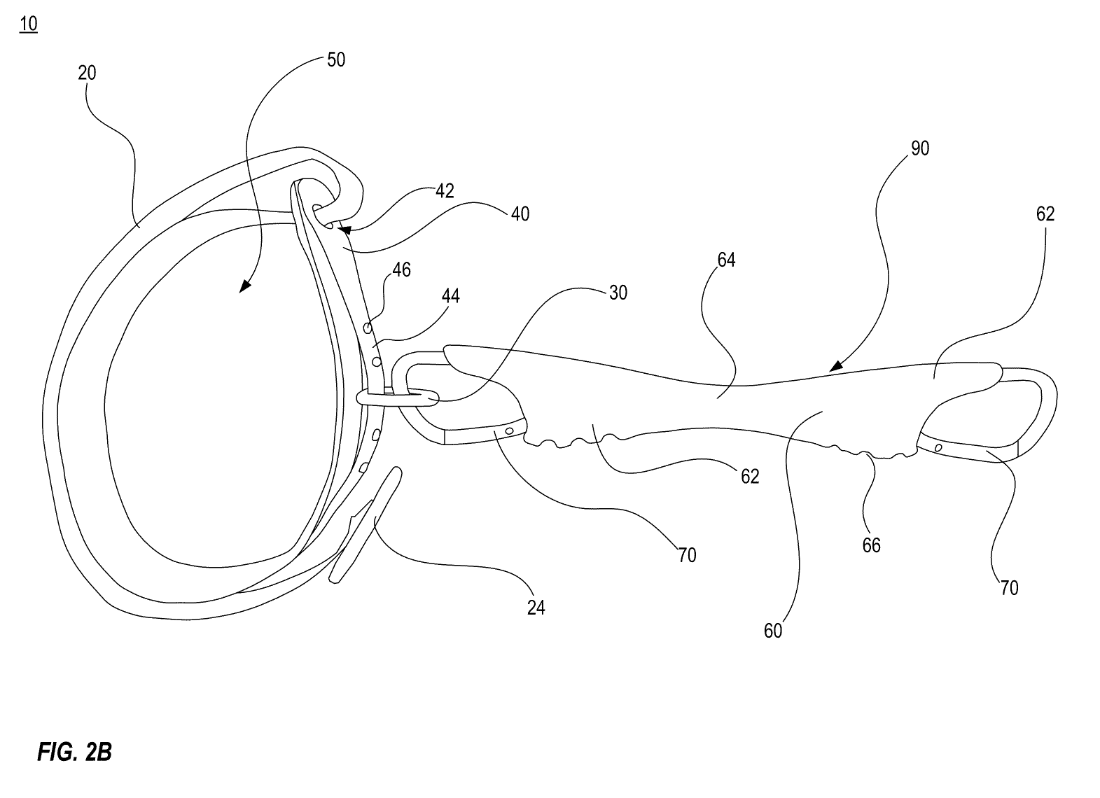

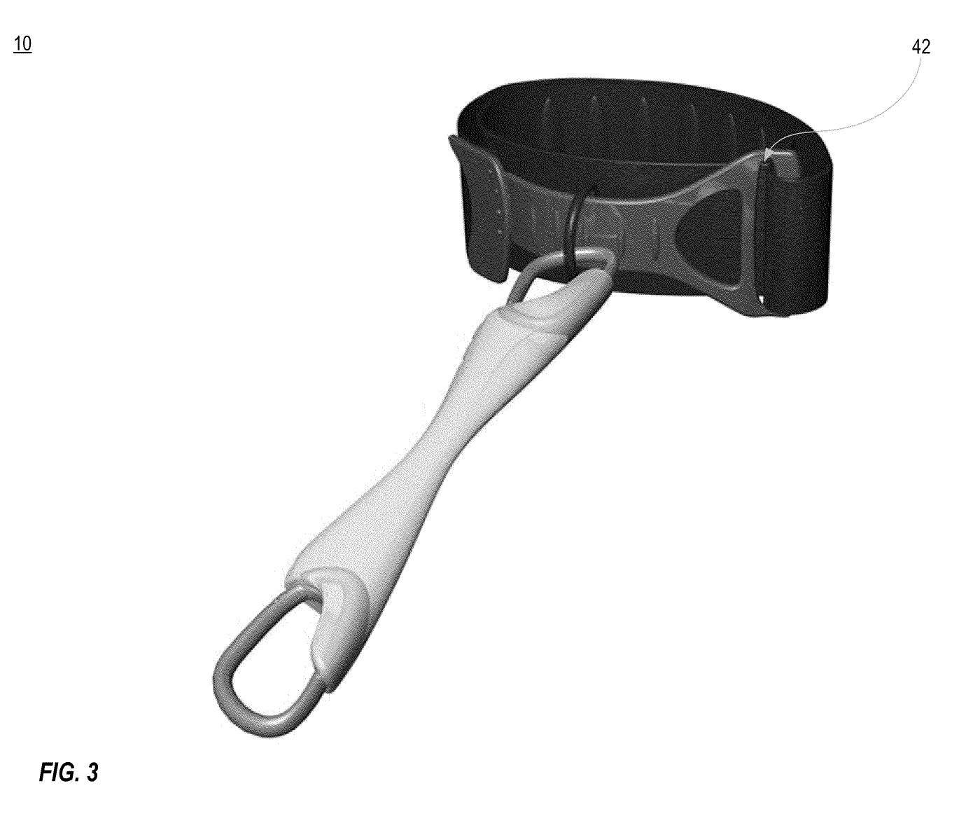

FIGS. 2A and 2B are top perspective views of a leash securing assembly 10 similar to that of FIGS. 1A and 1B. As perhaps best shown therein, the band member 20 comprises a strip of pliable or semi-pliable material having two ends, with the retention member 40 attached at or near a first end of the band member 20. More particularly, a proximal end of the retention member 40 is attached to the band member 20 a relatively short distance from the first end of the band member 20 such that a distal end of the retention member 40 is disposed proximate the first end of the band member 20. FIG. 3 is a perspective view of the leash securing assembly of FIGS. 1A and 1B, illustrating an eye 42 that is defined through the retention member 40 proximate the distal end of the retention member 40. Preferably, a corresponding eye is also defined through the band member 20, although in at least some alternative embodiments, the eye 42 is defined solely through the retention member 40. Still yet, in at least some alternative embodiments, the eye 42 is defined in a ring or loop coupled or secured to the retention member 40 or band member 20.

The band member 20 passes through the retention member eye 42 (and the band member eye if present) such that the band member 20 defines a generally elliptical loop 50, as can be seen in FIGS. 2A and 2B. In alternative embodiments, the loop 50 can be defined by the band member 20 together with the retention member 40.

The band member 20 may be wrapped back around on itself after passing through the eyes 42, as can be seen in FIGS. 2A and 2B. It will be appreciated that by varying the extent to which the band member 20 is wrapped back around on itself, i.e. by varying how large of a portion of the band member 20 has or has not passed through the eyes 42, the circumference of the loop 50 may be increased or decreased. Further, the band member 20 includes mating hook and loop fastener components on appropriate corresponding surfaces thereof such that after being wrapped back around on itself, the band member 20 may be secured to itself via the hook and loop fastener components, thereby generally fixing the circumference of the loop 50 until the band member 20 is unsecured.

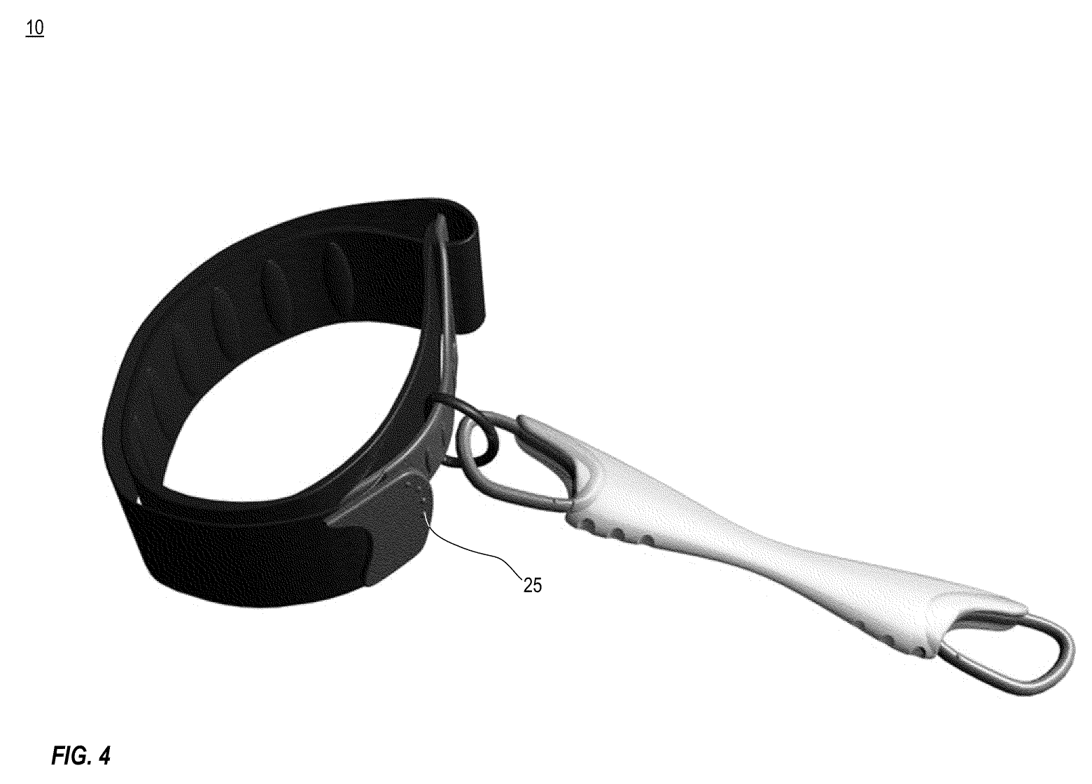

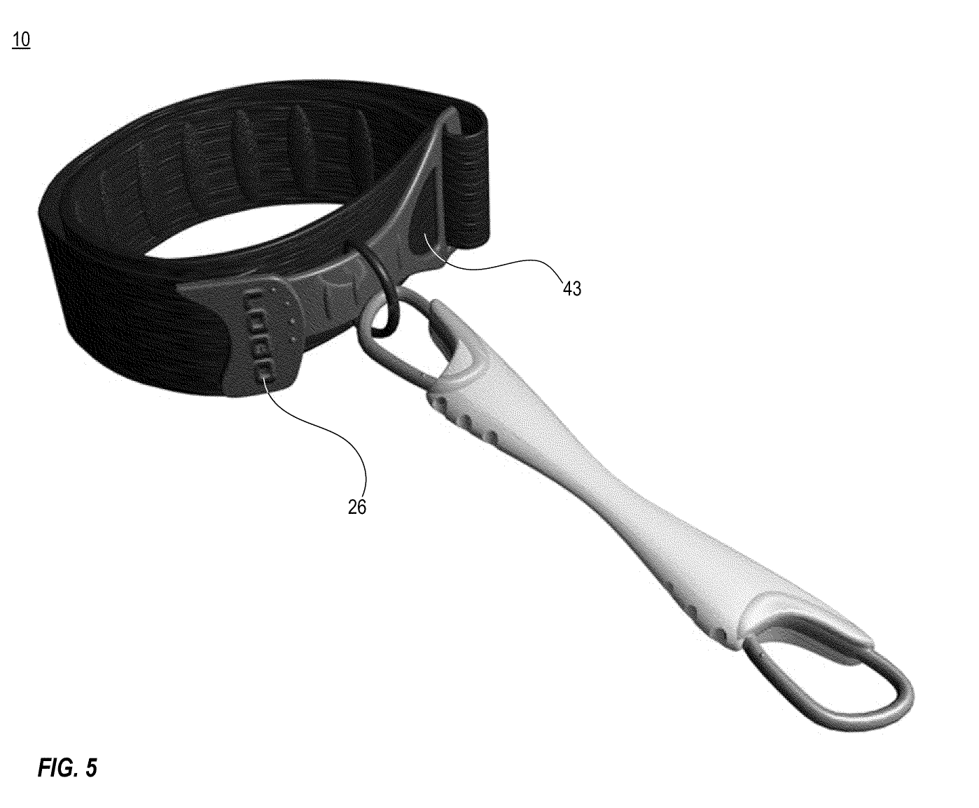

A tab member 24 is attached to the second end of the band member 20. The tab member 24 is configured to be easily grasped by a user, thus allowing the user to unsecure the band member much more easily than he or she would be able to without the tab member 24. The tab member 24 can include a plurality of raised dots 25, as can be seen in FIG. 4. The tab member 24 can further include a logo 26, as can be seen in FIG. 5.

It will be appreciated that when the band member 20 is configured as described, i.e., routed through the eyes 42, as shown in FIGS. 2A and 2B, each end of the retention member 40 is attached or secured to the band member 20, but a middle portion 44 of the retention member 40 is not, as can be seen in FIGS. 2A and 2B. The ring member 30 is dimensioned such that it may encircle this middle portion 44 and slide freely along it. It will be appreciated, however, that the ring member 30 does not encircle the retention member 40. Preferably, the ring member 30 has a semi-circular shape, although in alternative embodiments the ring member 30 can have any of a variety of shapes, including, but not limited to, a circular, triangular, or rectangular shape.

Preferably, as perhaps best shown in FIG. 5, the retention member 40 includes one or more cutouts 43, although in at least some embodiments these cutouts 43 are absent, such as in the leash securing assembly. Likewise, as shown for example in FIGS. 2A and 2B, the retention member 40 preferably includes one or more protrusions 46, although in at least some embodiments these protrusions 46 are absent. These protrusions 46 protrude on one or both sides of the retention member 40. It will be appreciated that when protruding on the side of the retention member 40 facing the band member 20, the protrusions 46 can hinder movement of the ring member 30 as it slides along the retention member 40.

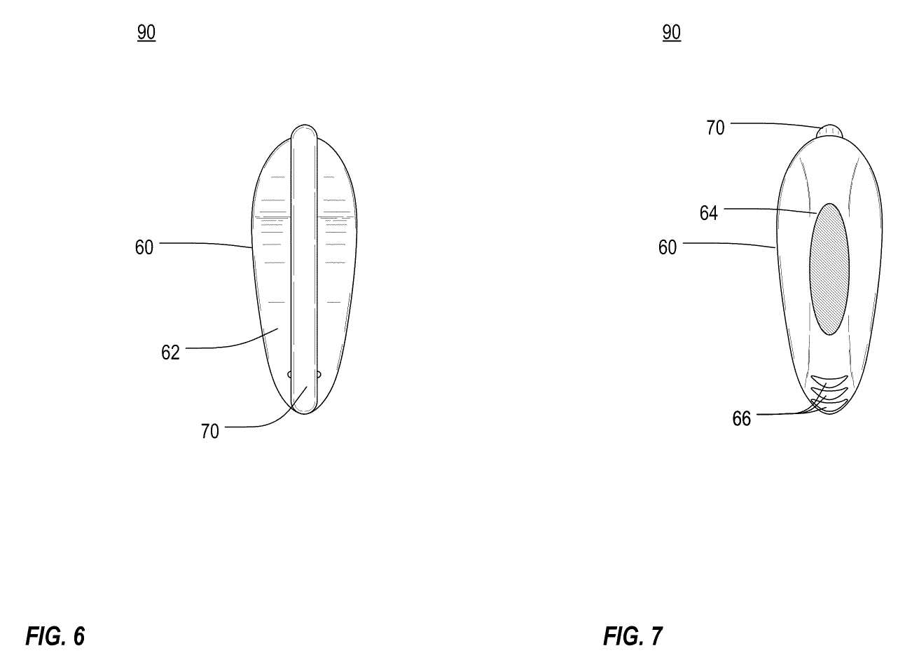

FIGS. 6 and 7 are an end view and an end cross-sectional view of the coupling device of FIGS. 1A and 1B. Referring particularly to FIGS. 6 and 7 as well as FIGS. 2A and 2B, the coupling device 90 includes an elastic member 60 having two ends 62. Embedded within each end 62 of the coupling device 90 is a carabineer 70. Each carabineer 70 is embedded within the elastic member 60 such that a hinged segment of the carabineer 70 may rotate inward about a hinge from a closed position towards an open position. A tension mechanism biases the hinged segment towards the closed position. It will be appreciated that many types of carabineers having hinge joints, tensioners and/or other closure mechanisms in various locations may be utilized in alternative embodiments. Further, in at least some embodiments, alternative fasteners other than carabineers may be utilized. Likewise, a carabineer, or alternative fastener, located at a first end does not have to be identical to a carabineer, or alternative fastener, located at a second end.

Each carabineer 70 may be comprised of any of a wide variety of materials including, but not limited to, aluminum or plastic. The elastic member 60 is preferably comprised of an elastomer material, and more preferably, the elastic member 60 is preferably comprised of either a thermoset or thermoplastic material.

As will be appreciated, the elastic member 60 is tapered such that a middle portion 64 of the elastic member 60 is narrower than either end 62 of the elastic member 60. The elastic member 60 is thus configured such that if tensioned sufficiently, the elastic member 60 will tend to break proximate the middle portion 64, rather than nearer the ends.

The elastic member 60 includes indentations 66 spanning a lateral side proximate each end 62. In at least some alternative embodiments, an elastic member 60 includes no indentations, includes more or less indentations, and/or includes indentations in other locations.

A more complete description of exemplary coupling devices that may be utilized in accordance with one or more preferred implementations is provided hereinbelow.

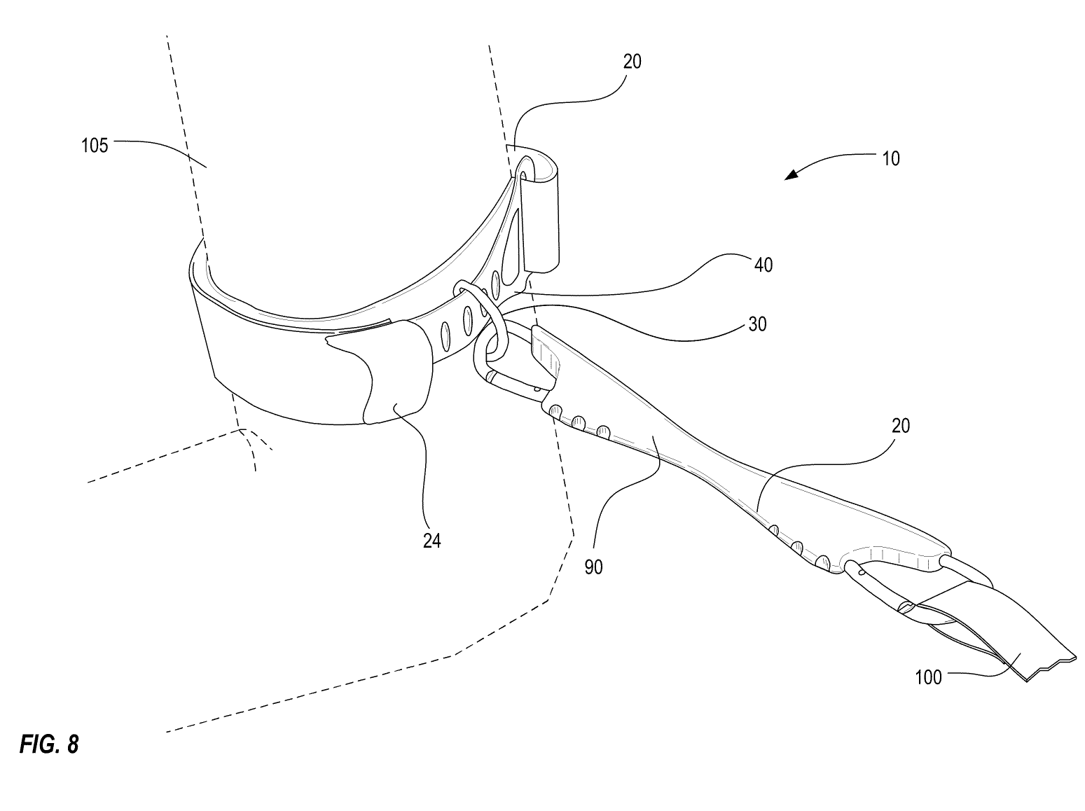

FIG. 8 is a perspective view of the leash securing assembly 10 of FIGS. 1A and 1B, shown in use. The ring member 30 may be conventionally coupled to a first of the carabineers 70 of the coupling device 90. The second carabineer 70 of the coupling device 90 may be coupled to an animal's leash 100.

To use the leash securing assembly 10, a user inserts one of his or her arms 105 into the loop 50 such that the leash securing assembly 10 is disposed proximate the user's upper arm 105 with the retention member 40 facing outwards away from their body. The user then decreases the circumference of the loop 50 by pulling the band member 20 further through the eyes 42. After passing through the eyes 42, the band member 20 is pulled back around, changing direction roughly one hundred and eighty (180) degrees, such that a portion of the band member 20 that has passed through the eyes 42 is located in covering relation to a portion of the band member 20 that has not passed through the eyes 42. The adjacent faces of the portions of the band member 20 together comprise a hook and loop fastener, which allows a user to secure the band member 20 to itself, thereby securing the leash securing assembly 10 to the user's arm 105.

A user next couples an animal leash 100 to the second carabineer 70 of the coupling device 90. Once this animal leash 100 is coupled to the second carabineer 70, a user secures the animal leash 100 to an animal, if this has not already been done. It will be appreciated that a user can secure the animal leash 100 to an animal before or after coupling the animal leash 100 to the second carabineer 70. A user can then walk, jog, or run together with the animal, without being required to use his or her hands to hold the animal leash 100. It will be appreciated that while walking, jogging, or running, the ring member 30 may slide freely along the retention member 40, thereby providing a smoother experience for both the user and the animal.

It will be appreciated that some animals are stronger or more forceful than other animals. Certain strong and forceful animals present a possible danger to a user, particularly if the user is not particularly strong. For example, a one hundred ten pound woman may have difficulty controlling a one hundred pound dog on a leash coupled to the leash securing assembly 10. Preferably, the elastic member 60 of the coupling member 90 is configured to break proximate the middle portion 64 when tensioned to a certain degree. The degree of tensioning required before the elastic member 60 breaks may be varied in different embodiments. It is contemplated that different coupling members 90 be sold either together with, or separate from, a leash securing assembly 10. For example, different coupling members designed to break under low, medium and high tensional forces may be offered for sale. These coupling members 90 could be freely interchanged as the user desires.

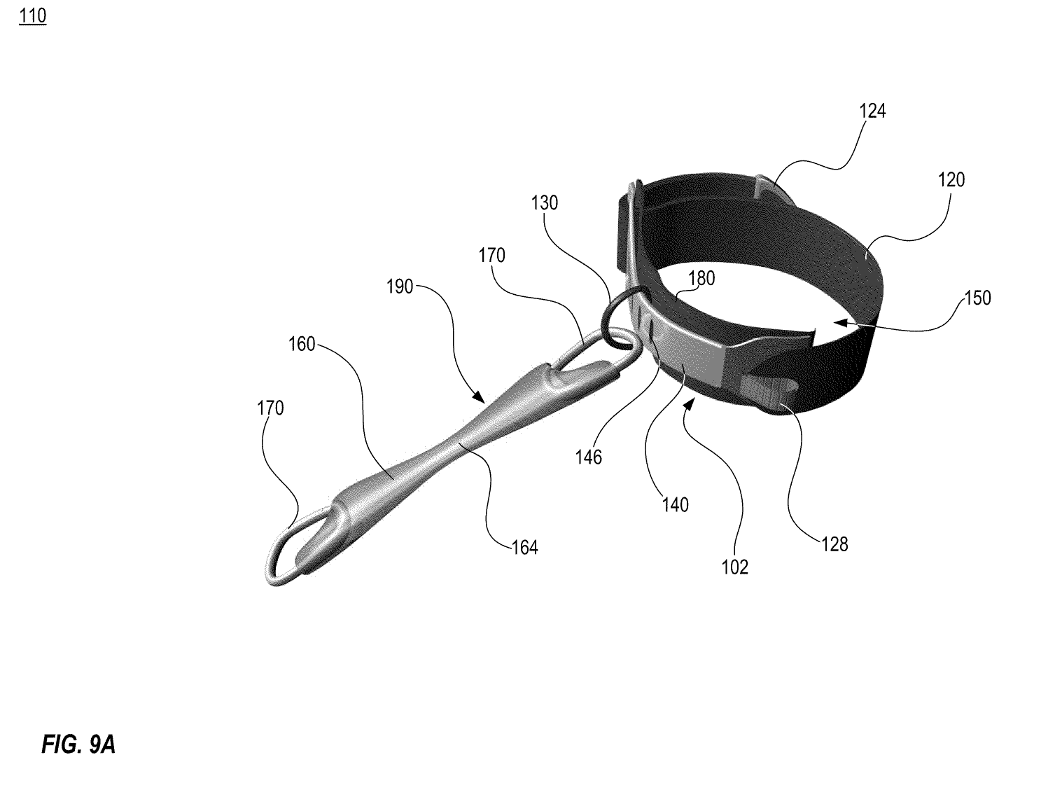

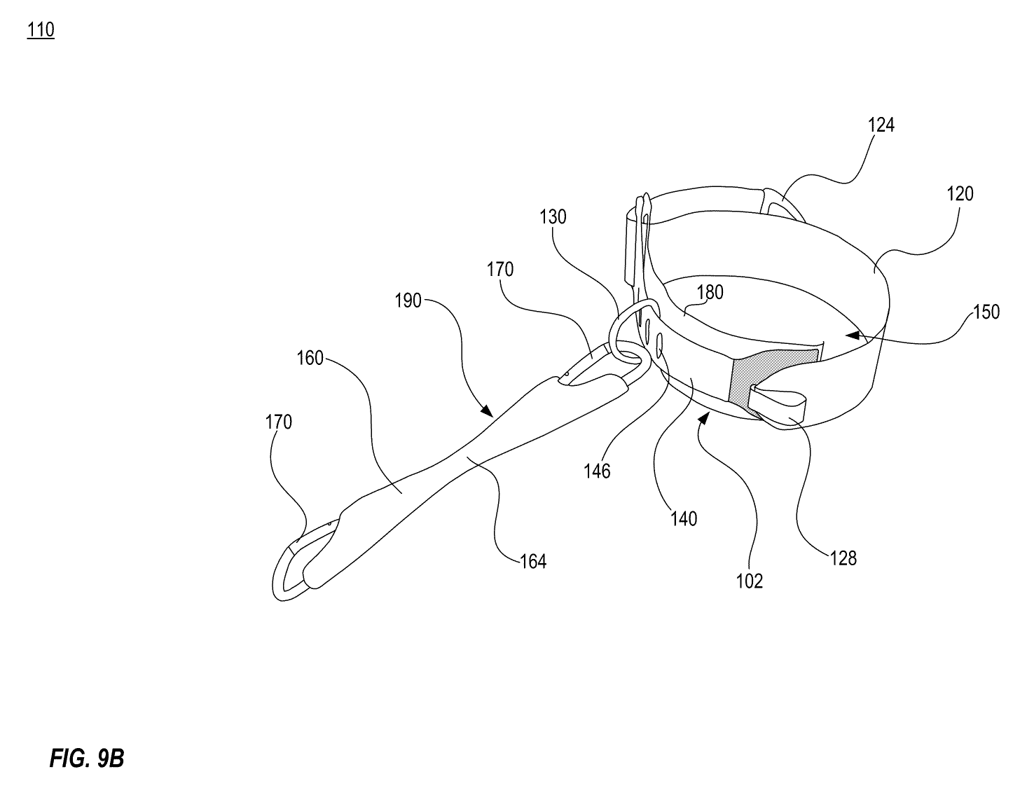

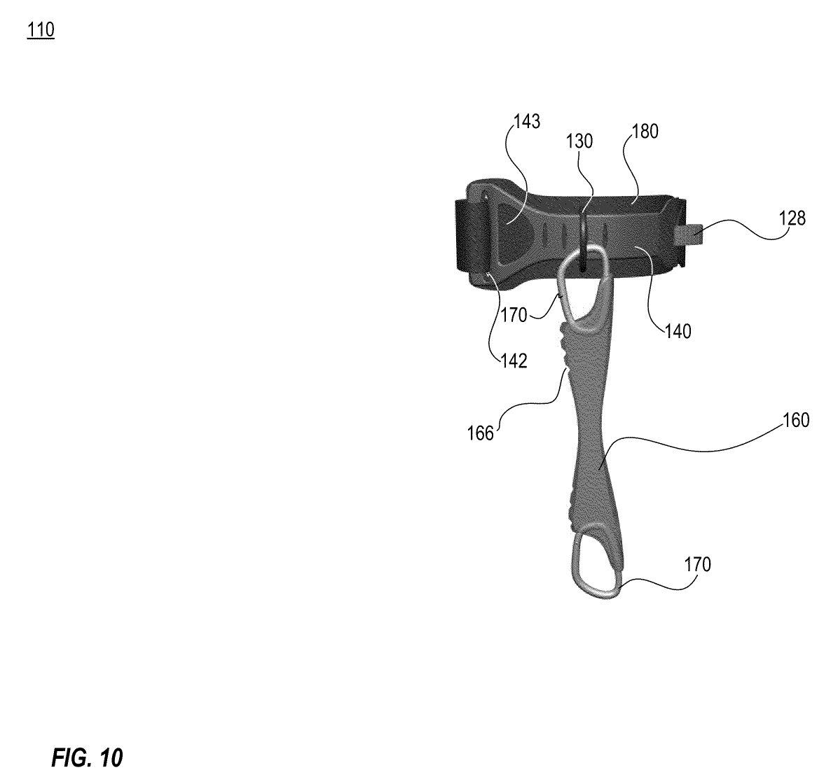

FIGS. 9A and 9B are perspective views of a leash securing assembly 110 in accordance with another preferred embodiment of the present invention, and FIG. 10 is a front plan view of the leash securing assembly of FIGS. 9A and 9B. The leash securing assembly 110 includes a band member 120, a ring member 130, a coupling device 190, and a retention device 102. The retention device 102 includes a retention member 140 and a backing member 180.

The band member 120 comprises a strip of pliable or semi-pliable material having two ends. A proximal end of the retention member 140 is attached to the backing member 180 such that a distal end of the retention member is disposed proximate a distal end of the backing member 180. An eye 142 is defined through the retention member 140 proximate the distal end of the retention member 140, as can be seen in FIG. 10. Preferably, a corresponding eye is also defined through the backing member 180. In at least some alternative embodiments, the eye 142 is defined solely through either the retention member 140 or the backing member 180. Still yet, in at least some alternative embodiments, the eye 142 is defined in a ring or loop coupled or secured to the retention member 140 or backing member 180.

The proximal end of the retention member 140 includes a hook and loop fastener. A first end of the band member 120 includes a mating hook and loop fastener for attachment to the proximal end of the retention member 140. A user can attach the proximal end of the retention member 140 to the first end of the band member 120 using the mating hook and loop fasteners, as can be seen in FIGS. 9A and 9B.

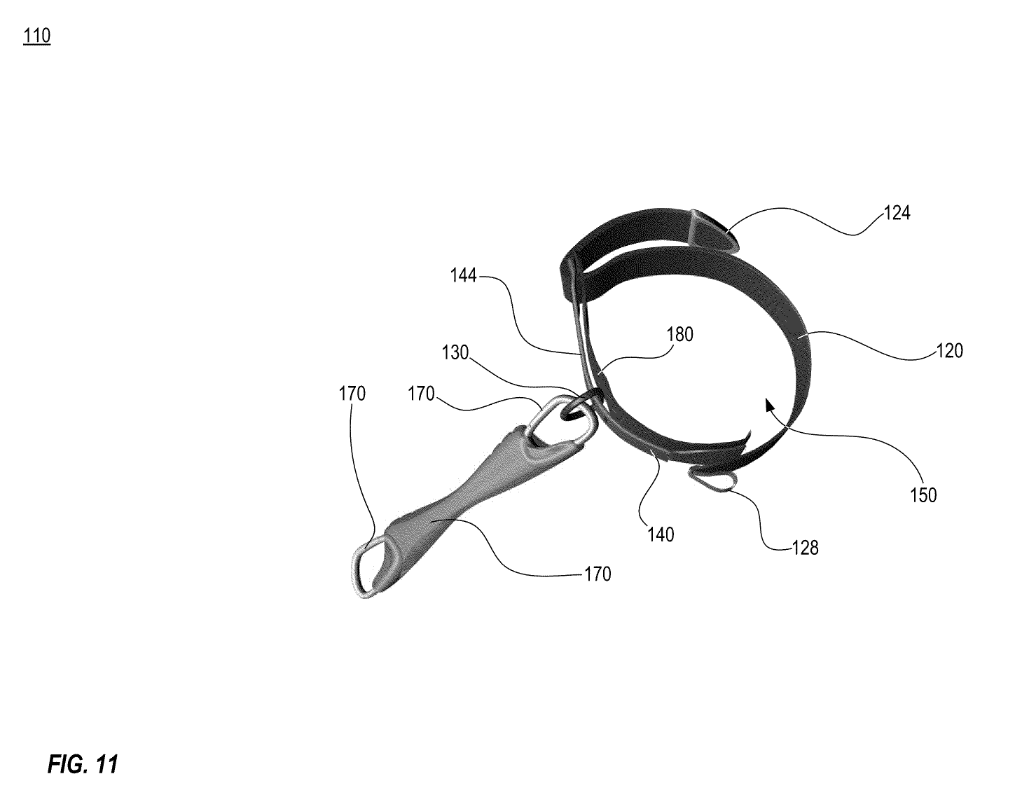

FIG. 11 is a top perspective view of the leash securing assembly of FIGS. 9A and 9B. After the first end of the band member 120 is attached to the proximal end of the retention member 140, a second end of the band member 120 is routed through the retention member eye 142 (and the backing member eye if present) such that the band member 120 and the backing member 180 together define a generally elliptical loop 150, as can be seen in FIG. 11.

After the band member 120 passes through the eyes 142, it may be wrapped back around on itself, as can be seen in FIG. 11. It will be appreciated that by varying the extent to which the band member 120 is wrapped back around on itself, i.e. by varying how large of a portion of the band member has or has not passed through the eye 142, the circumference of the loop 150 may be increased or decreased. Further, the band member 120 includes mating hook and loop fastener components, such that after being wrapped back around on itself, the band member 120 may be secured to itself via the hook and loop fastener, thereby generally fixing the circumference of the loop 150 until the band member 120 is unsecured.

The second end of the band member 120 is attached to a tab member 124. The tab member 124 is configured to be easily grasped by a user, thus allowing the user to unsecure the band member much more easily than he or she would be able to without the tab member 124. The tab member 124 can include a plurality of raised dots and/or a logo.

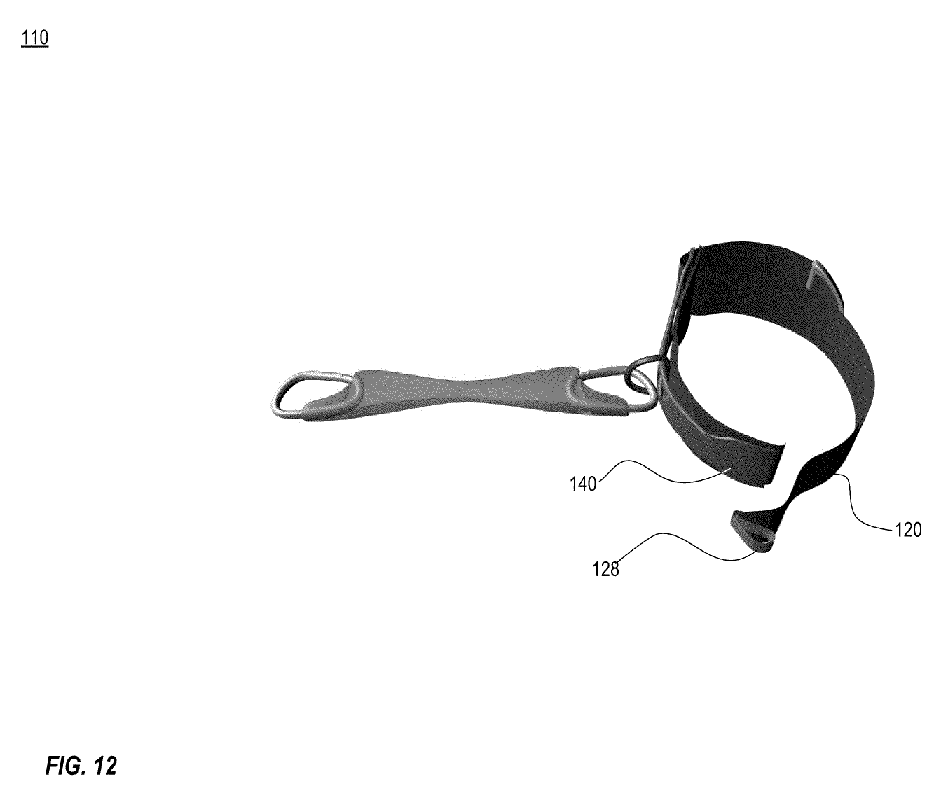

Further, the first end of the band member 120 includes a finger loop 128. A user may insert a finger into the finger loop 128 and/or grasp the finger loop 128 to aid in separating the hook and loop fastener of the first end of the band member 120 from the hook and loop fastener of the retention member 140. It will be appreciated that this allows a user to unsecure the band member much more quickly and easily than he or she would be able to without the finger loop 128. FIG. 12 illustrates how the first end of the band member 120 can be separated from the retention member 140.

It will further be appreciated that although each end of the retention member 140 is attached or secured to the backing member 180, a middle portion 144 of the retention member 140 is not, as can be seen in FIG. 11. The ring member 130 is dimensioned such that it may encircle this middle portion 144 and slide freely along it. It will be appreciated, however, that the ring member 130 does not encircle the retention member 140. Preferably, the ring member 130 has a semi-circular shape, although in alternative embodiments the ring member 130 can have any of a variety of shapes, including, but not limited to, a circular, triangular, or rectangular shape.

Preferably, the retention member 140 includes one or more cutouts 143, although in at least some embodiments these cutouts 143 are absent. Likewise, the retention member 140 preferably includes one or more protrusions 146, although in at least some embodiments these protrusions 146 are absent. These protrusions 146 protrude on one or both sides of the retention member 140. It will be appreciated that when protruding on the side of the retention member 40 facing the band member 120, the protrusions 146 can hinder movement of the ring member 30 as it slides along the retention member 140.

The coupling device 190 includes an elastic member 160 having two ends. A more complete description of such a coupling device may once again be found in the disclosure of Appendix A, but for convenience a partial description is also provided herein. Embedded within each end 162 of the coupling device 190 is a carabineer 170. Each carabineer 170 is embedded within the elastic member 160 such that a hinged segment of the carabineer 170 may rotate inward about a hinge from a closed position towards an open position. A tension mechanism biases the hinged segment towards the closed position. It will be appreciated that many types of carabineers having hinge joints, tensioners and/or other closure mechanisms in various locations may be utilized in alternative embodiments. Further, in at least some embodiments, alternative fasteners other than carabineers may be utilized. Likewise, a carabineer, or alternative fastener, located at a first end does not have to be identical to a carabineer, or alternative fastener, located at a second end.

Each carabineer 170 may be comprised of any of a wide variety of materials including, but not limited to, aluminum or plastic. The elastic member 160 is preferably comprised of an elastomer material, and more preferably, the elastic member 60 is preferably comprised of either a thermoset or thermoplastic material.

As will be appreciated, the elastic member is tapered such that a middle portion 164 of the elastic member 160 is narrower than either end 162 of the elastic member 160. The elastic member 160 is thus configured such that if tensioned sufficiently, the elastic member 160 will tend to break proximate the middle portion 164, rather than nearer the ends 62.

The elastic member 160 includes indentations 166 spanning a lateral side proximate each end 162, as can be seen in FIG. 10. In at least some alternative embodiments, an elastic member 160 includes no indentations, includes more or less indentations, and/or includes indentations in other locations.

The ring member 130 is conventionally coupled to a first of the carabineers 170 of the coupling device 190. The second carabineer 170 of the coupling device 190 may be coupled to an animal's leash 100.

In use, a user first attaches the first end of the band member 120 to the proximal end of the retention member 140 via the hook and loop fasteners. Next, the second end of the band member 120 is routed through the eye 142 such that the band member 120 and the backing member 180 together define a generally elliptical loop 150.

A user then inserts an arm 105 into the loop 150 such that the leash securing assembly 110 is disposed proximate a user's upper arm 105 with the retention member 140 facing outwards away from their body. The user then decreases the circumference of the loop 150 by pulling the band member 120 further through the eye 142. After passing through the eye 142, the band member 120 is pulled back around, changing direction roughly one hundred and eighty (180) degrees, such that a portion of the band member 120 that has passed through the eye 142 is located in covering relation to a portion of the band member 120 that has not passed through the eye 142. The adjacent faces of the portions of the band member 120 together comprise a hook and loop fastener, which allows a user to secure the band member 120 to itself, thereby securing the leash securing assembly 110 to the user's arm 105.

A user next couples an animal leash 100 to the second carabineer 170 of the coupling device 190. Once this animal leash 100 is coupled to the second carabineer 170, a user secures the animal leash 100 to an animal, if this has not already been done. It will be appreciated that a user can secure the animal leash 100 to an animal before or after coupling the animal leash 100 to the second carabineer 170. A user can then walk, jog, or run together with the animal, without being required to use his or her hands to hold the animal leash 100. It will be appreciated that while walking, jogging, or running, the ring member 130 may slide freely along the retention member 140, thereby providing a smoother experience for both the user and the animal.

When the user desires to remove the leash securing assembly 110, he or she may engage either the tab member 124 or the finger loop 128 to unsecure the band member 120.

It will be appreciated that some animals are stronger or more forceful than other animals. Strong and forceful animals can be a danger to a user, particularly if the user is not particularly strong. For example, a one hundred ten pound woman may have difficulty controlling a one hundred pound dog on a leash 100 coupled to the leash securing assembly 110. Preferably, the elastic member 160 of the coupling member 190 is configured to break proximate the middle portion 164 when tensioned to a certain degree. The degree of tensioning required before the elastic member 160 breaks may be varied in different embodiments. It is contemplated that different coupling members 190 be sold either together with, or separate from, a leash securing assembly 110. For example, different coupling members designed to break under low, medium and high tensional forces may be offered for sale. These coupling members 190 could be freely interchanged as the user desires.

Further, as an additional safety measure, a user can engage the finger loop 128 to quickly release the leash securing assembly 110 from around his or her arm 105.

### Leash Securing Assembly With Shock Cord

FIG. 13 is a perspective view of a leash securing assembly 210 in accordance with another preferred embodiment of the present invention. The leash securing assembly 210 includes a cuff 220 and a shock cord 290.

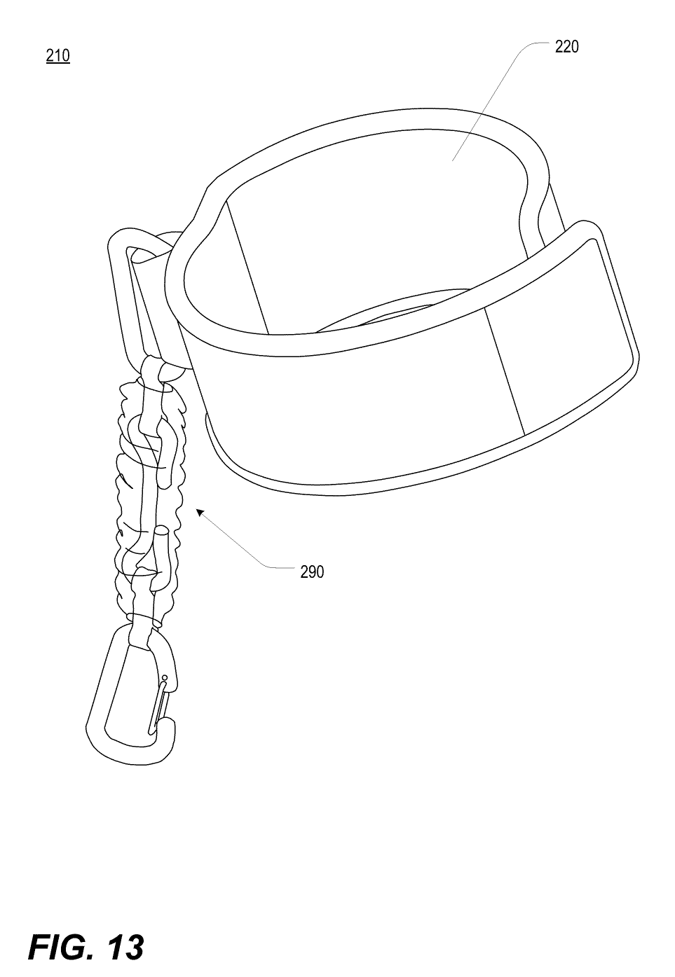

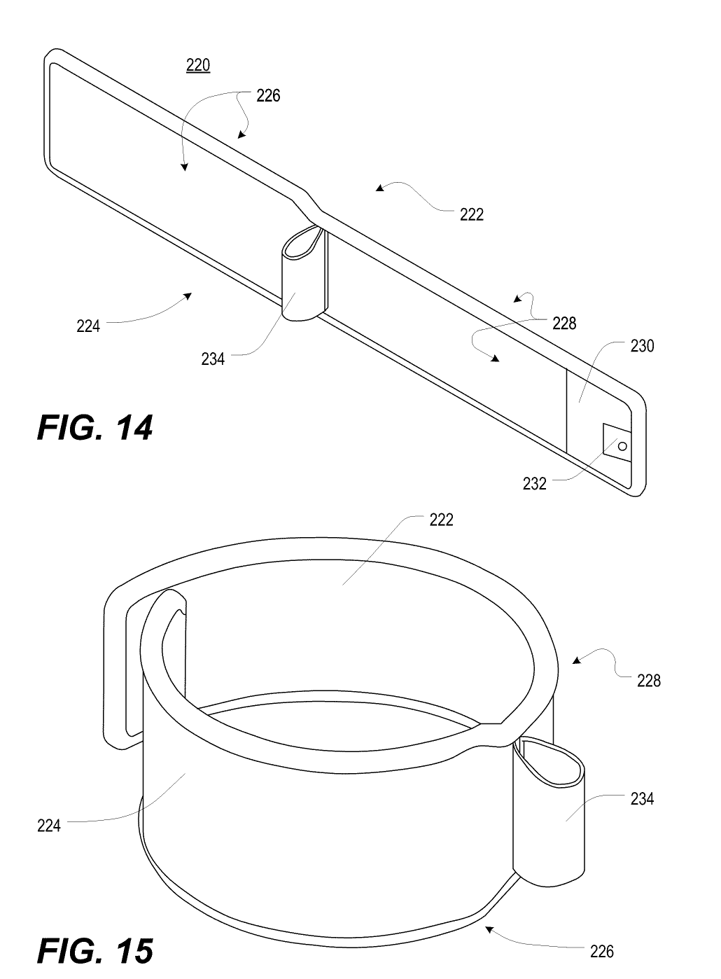

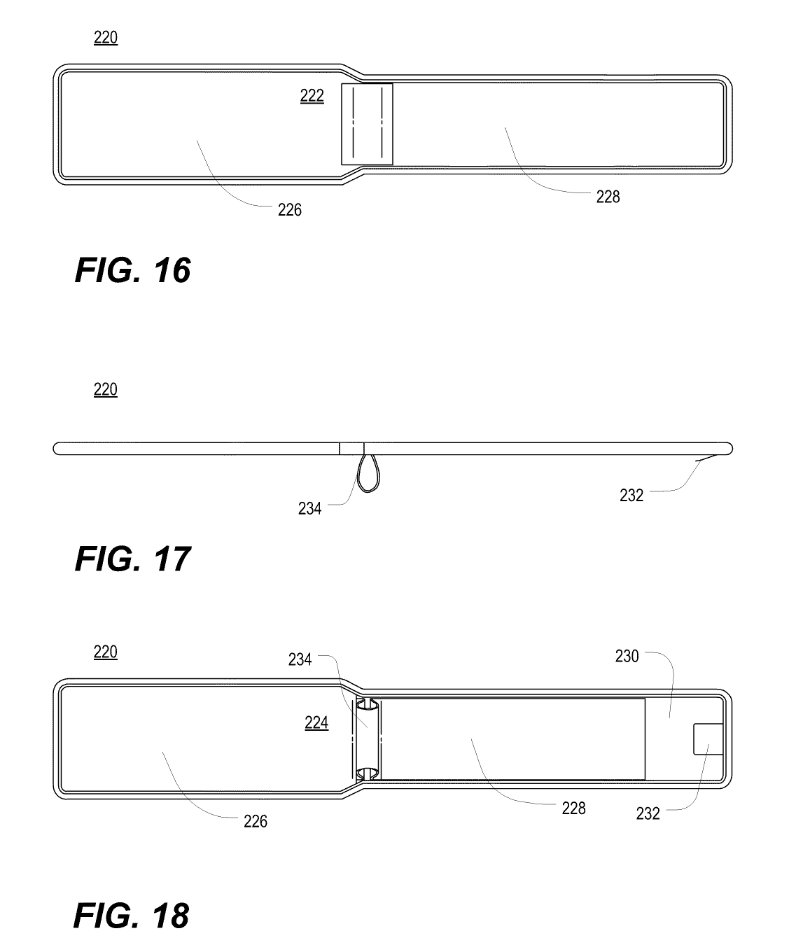

FIGS. 14-18 are further views of the cuff 220, which comprises a strip of pliable or semi-pliable material having a generally rectangular shape with an interior face 222, an exterior face 224. FIG. 14 is a perspective view of the cuff 220 in an open configuration. FIG. 15 is a perspective view of the cuff 220 in a closed configuration where the cuff 220 is secured to itself via hook and loop fastening components (e.g., Velcro). FIGS. 16, 17, and 18 are inside, top, and outside views of the cuff 220, respectively. Each face of the cuff 220 can be characterized as including two sides, a hook side and a loop side. The interior face 222 comprises black fabric neoprene on the hook side 226, and 2-inch black black sewable knit nylon loop 238 with a high shear strength on the loop side 228. The exterior face 224 comprises 2-inch black sewable hook with a very high shear strength on the hook side 226, and 2-inch nylon webbing on the loop side 228. In at least some embodiments, the exterior face further comprises an embroidered label 230 and a pull tab 232 made of nylon webbing and designed for a quick release, as illustrated in FIG. 18. Preferably, a webbing loop 234 designed for attachment of a carabineer is secured to the exterior face 224 of the cuff 220 generally between the hook and loop sides via stitching. Preferably, reinforcement webbing 236 is used on the interior face 222 of the cuff 220 to secure the webbing loop 234 in place.

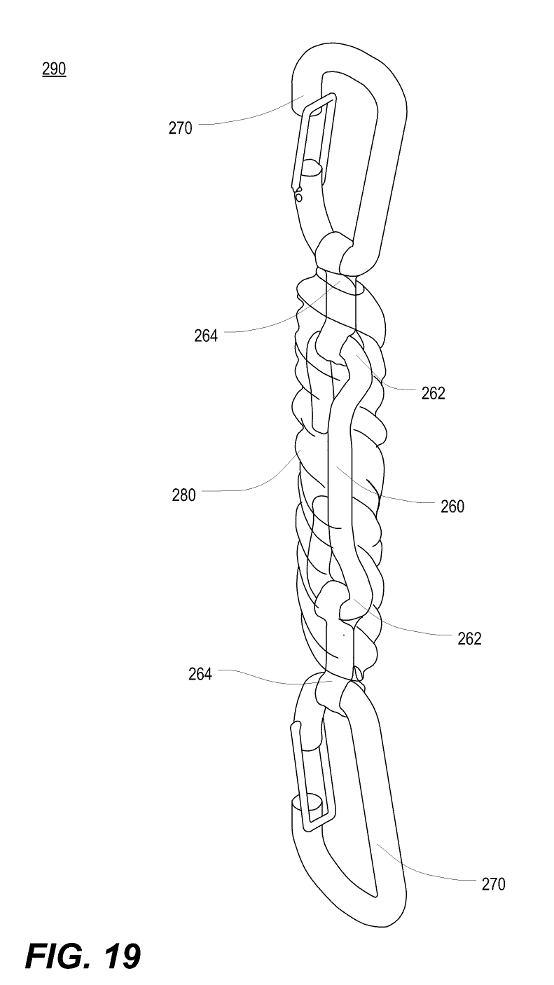

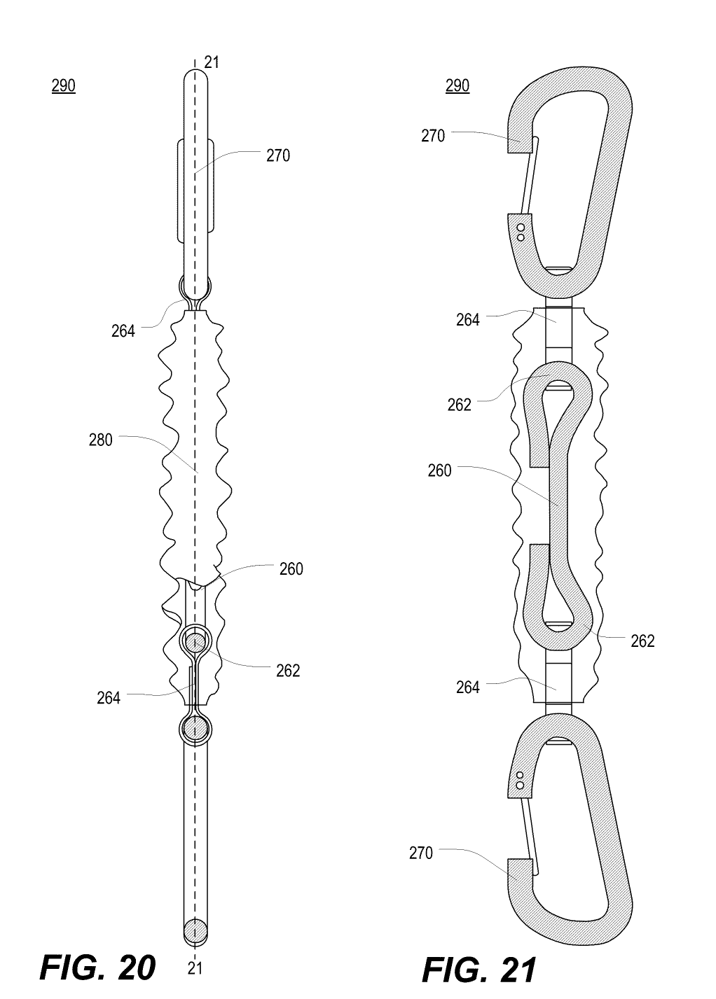

FIG. 19 is a front perspective view of the shock cord 290. FIG. 20 is a side view of the shock cord 290, where the bottom half is shown in cross section. FIG. 21 is a front cross-sectional view of the shock cord 290. Referring to FIGS. 19-21, the shock cord 290 comprises an elastic member 260 having two ends 262, two carabineers 270, sections of webbing 264 each connecting one of the ends 262 to one of the carabineers 270, and an outer sheath 280 enclosing the elastic member 260, and, preferably, at least a portion of the sections of webbing 264.

Referring particularly to FIGS. 19-21, the shock cord 290 includes an elastic member 260 having two ends 262. Each end 262 of the shock cord 290 is attached to a respective carabineer 270 via a respective webbing 264. Each carabineer 270 has a hinged segment that may rotate inward about a hinge from a closed position towards an open position. A tension mechanism biases the hinged segment towards the closed position. It will be appreciated that many types of carabineers having hinge joints, tensioners and/or other closure mechanisms in various locations may be utilized in alternative embodiments. Further, in at least some embodiments, alternative fasteners other than carabineers may be utilized. Likewise, a carabineer, or alternative fastener, located at a first end of a shock cord does not have to be identical to a carabineer, or alternative fastener, located at a second end of a shock cord.

Each carabineer 270 may be comprised of any of a wide variety of materials including, but not limited to, aluminum or plastic. The elastic member 260 is preferably comprised of an elastomer material, and more preferably, the elastic member 260 is preferably a fabric-covered latex rubber cord or bungee cord. The webbing 264 is preferably comprised of nylon. The outer sheath 280 is preferably comprised of a nylon tubular webbing.

FIG. 13 is a perspective view of the leash securing assembly 210 shown in use. One of the carabineers 270 of the shock cord 290 is coupled to the nylon loop 238 of the cuff 220. The other carabineer 270 of the shock cord 290 may, for example, be coupled to an animal's leash 292.

In a preferred method of using a leash securing assembly 210, a user places the cuff 220 around one of his or her arms such that the leash securing assembly 210 is disposed proximate the user's upper arm with the shock cord 290 facing outwards away from the user's body. The user then wraps the cuff 220 around his or her arm such that the cuff 220 encircles his or her arm and overlaps itself, and specifically such that the loop side of the interior face is adjacent the hook side of the exterior face. The user then secures the loop fastening components of the interior face and the hook fastening components of the exterior face together, thereby securing the leash securing assembly 210 to his or her arm. Either prior to, or subsequent to, securing the leash securing assembly 210 to his or her arm, the user (or another person or entity) couples one of the carabineers 270 of the shock cord 290 to the nylon loop 238 of the cuff 220.

Similarly, either prior to, or subsequent to, the above described steps, a user couples an animal leash to the second carabineer 270 of the shock cord 290. Once this animal leash is coupled to the second carabineer 270, a user may secure the animal leash to an animal, if this has not already been done. It will be appreciated that a user can secure the animal leash to an animal before or after coupling the animal leash to the second carabineer 270. In fact, it will be appreciated that the steps described hereinabove can be performed in nearly any sequence, each of which is contemplated in accordance with one or more preferred implementations. A user can then walk, jog, or run together with the animal, without being required to use his or her hands to hold the animal leash.

### Coupling Device

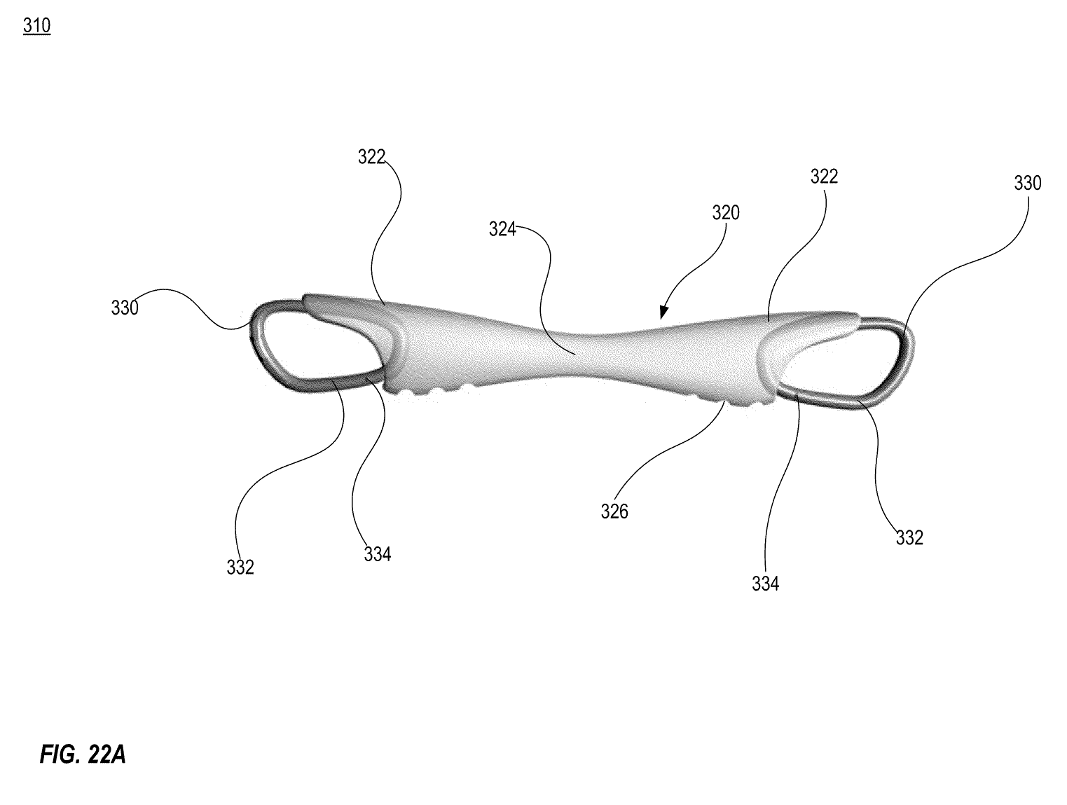

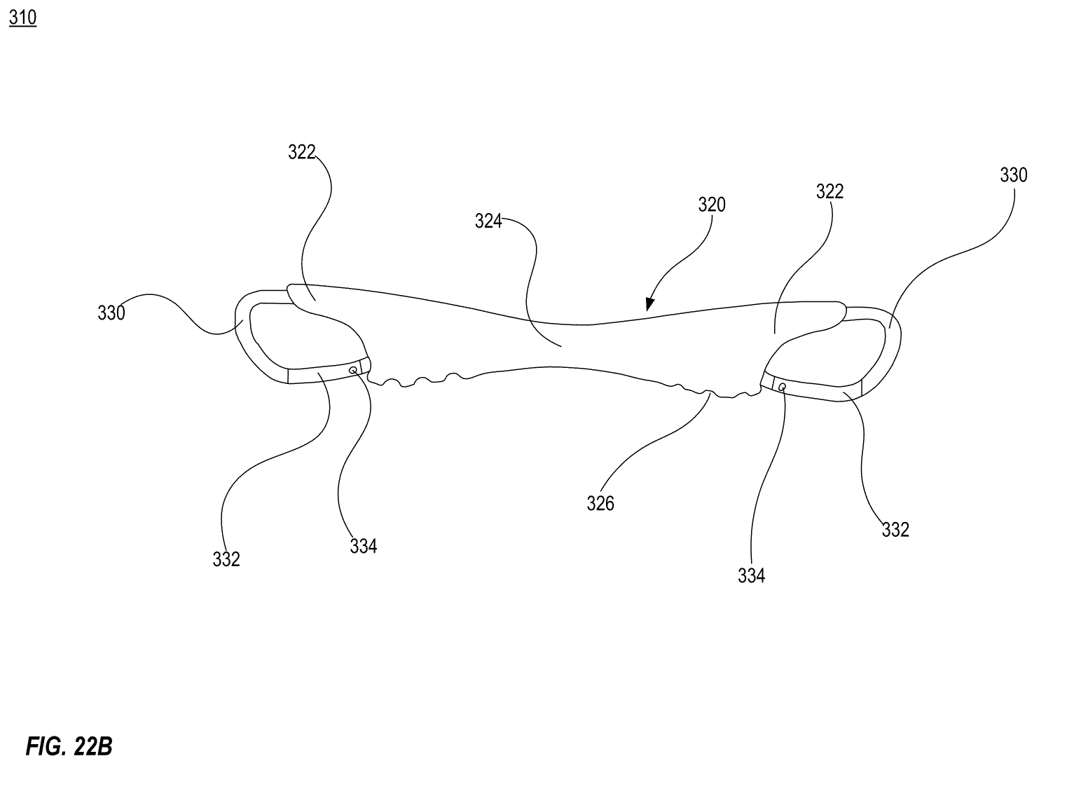

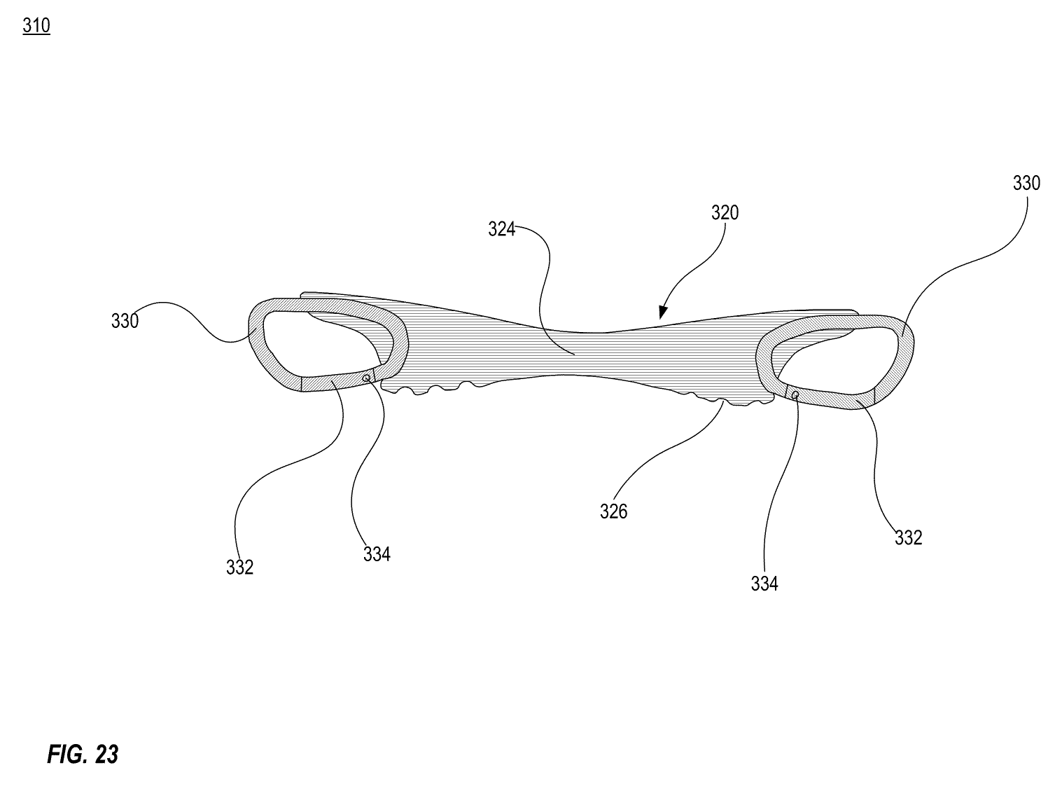

FIGS. 22A and 22B are each a top view of a coupling device 310 in accordance with one or more preferred embodiments of the present invention, and FIG. 23 is a top cross-sectional view of the coupling device 310 of FIGS. 22A and 22B. The coupling device 310 includes an elastic member 320 having two ends 322. Embedded within the coupling device 310 at each end 322 is a carabineer 330, as can be seen more clearly in FIG. 23, in which embedded portions of the carabineers 330 are shown in cross-section within the ends 322 of the coupling device 310.

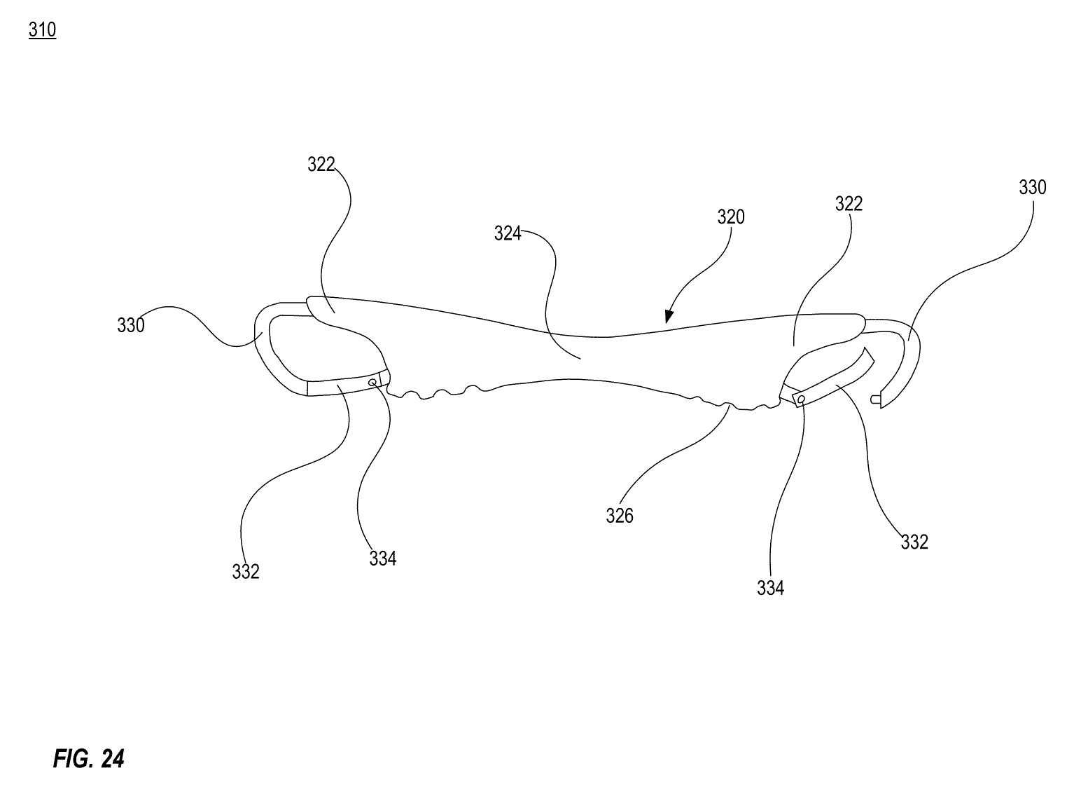

FIG. 3 is a top view of the coupling device 310 of FIGS. 22A and 22B illustrating how a hinged segment 332 of a carabineer 330 may be rotated about a hinge 334. As can be seen therein, each carabineer 330 is embedded within the elastic member 320 such that a hinged segment 332 may rotate inward about a hinge 334 from a closed position (FIGS. 22A and 22B) toward an open position (FIG. 24). A tension mechanism biases the hinged segment 332 toward the closed position. It will be appreciated that many types of carabineers having hinge joints, tensioners and/or other closure mechanisms in various locations may be utilized in alternative embodiments. Further, in at least some embodiments, alternative fasteners other than carabineers may be utilized. Further still, rather than a fastener, a link to a fastener, or an object linked to a fastener, may be embedded within the elastic member 320. Likewise, a carabineer, or alternative fastener, located at one end does not have to be identical to a carabineer, or alternative fastener, located at the opposite end. Carabineers, fasteners, links, or the like that are suitable for use in the preferred embodiments of the present invention can be comprised of aluminum, plastic, or any other compound or material known to be suitable.

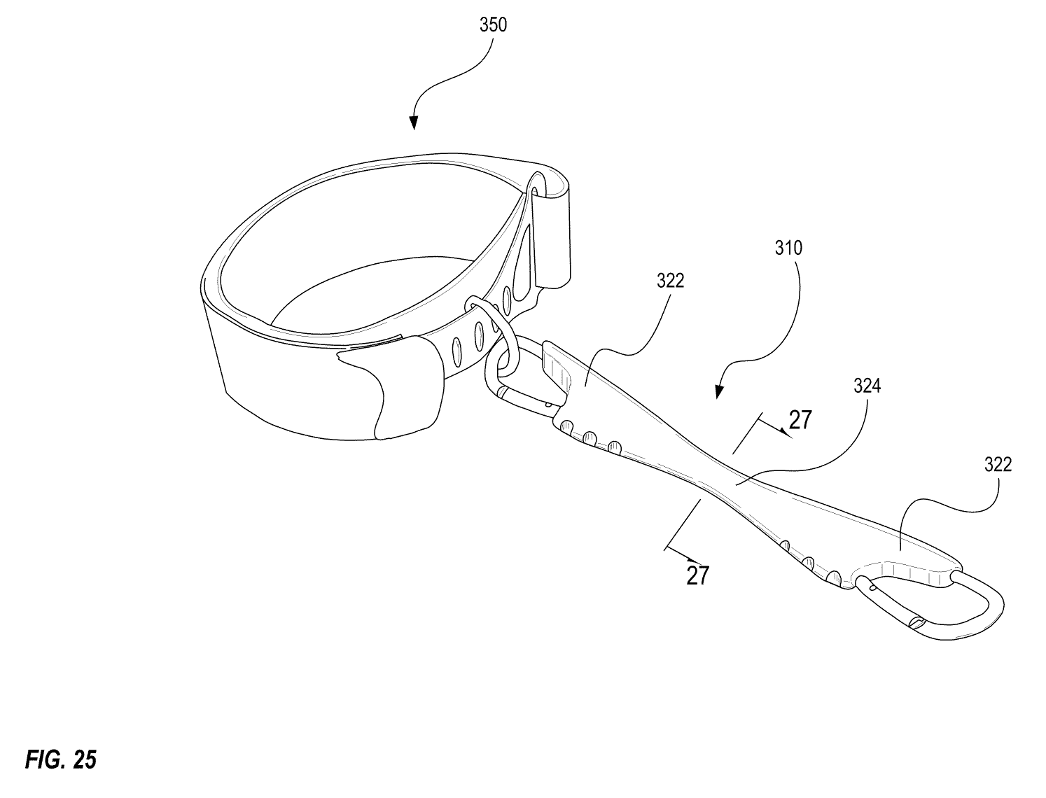

FIG. 25 is an environmental perspective view of the coupling device 310 of FIGS. 22A and 22B shown coupled to an armband 350. Such an arrangement is an example of an application for the coupling device 310 of the present invention as more fully discussed hereinabove.

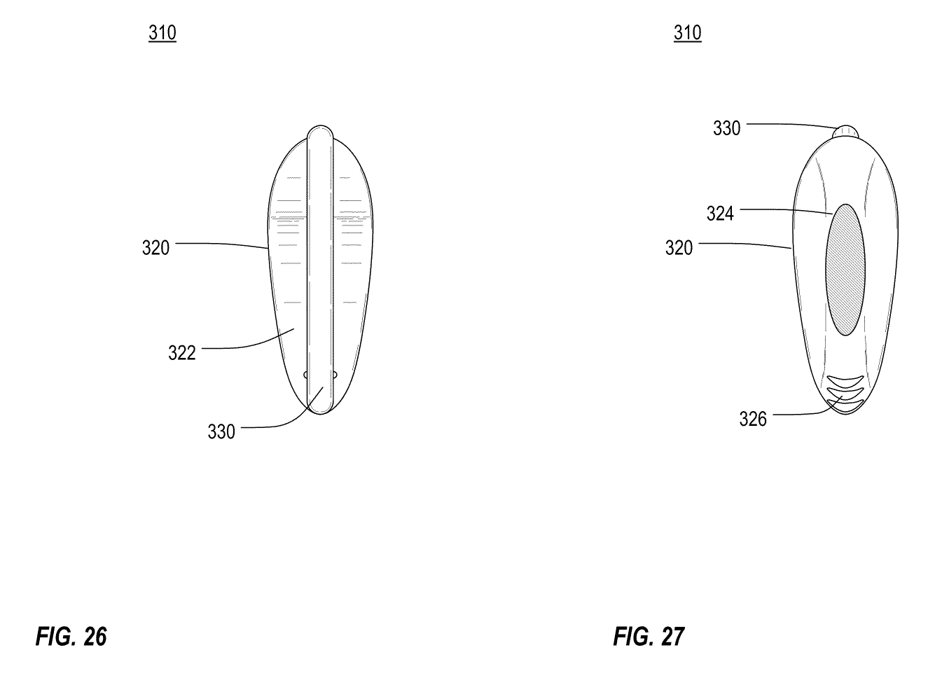

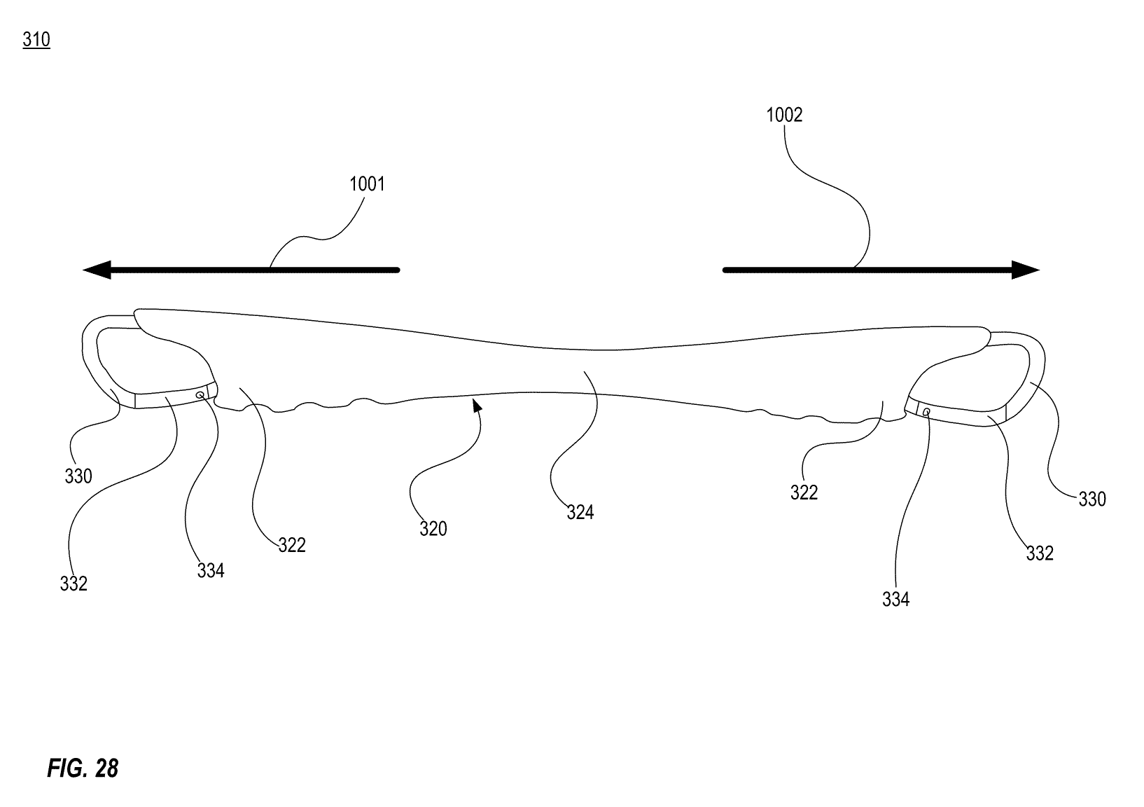

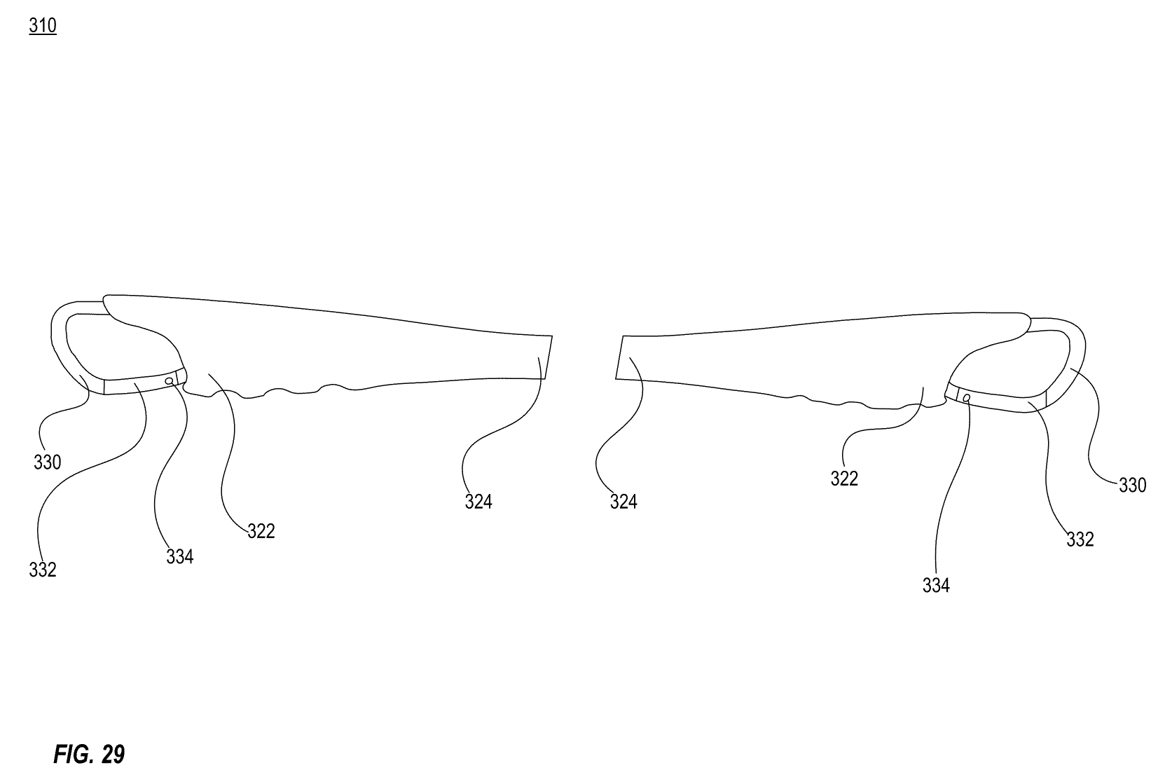

FIG. 26 is an end view of the coupling device 310 of FIG. 25, and FIG. 27 is an end cross-sectional view of the coupling device 310 of FIG. 25, taken along line 6-6. The elastic member 320 is preferably comprised of elastomeric material. In a preferred embodiment, the elastomeric material is a thermoplastic rubber. As perhaps best seen in FIGS. 25 and 27, a middle portion 324 of the elastic member 320 is narrower than either end 322 of the elastic member 320. The elastic member 320 is thus configured such that if tensioned, the elastic member 320 will break in the region of the middle portion 324. FIGS. 22A and 22B illustrate the coupling device 310 at rest, while FIG. 28 is an illustration of the same coupling device 310 under tension. Force lines 1001 and 1002 represent force applied to the coupling device 310. FIG. 29 illustrates a coupling device 310 that has broken proximate the middle portion 324 as a result of the tensioning illustrated in FIG. 28.

The elastic member 320 includes indentations 326 spanning a lateral side proximate each end 322, as can be seen in FIGS. 22A and 22B. In at least some alternative embodiments, an elastic member 320 includes no indentations, or includes more or less indentations located at the same location, or other locations.

In accordance with one or more aspects of the present invention, a coupling device 310 can be manufactured by injection molding. Specifically, a mold is created that is dimensioned to create an elastic member of the size and shape desired. One or more carabineers 330, and/or other fasteners, are then positioned relative to the mold in a desired orientation. Next, a heated elastomeric substance is injected into the mold. In this way, a coupling device 310 is created via injection molding that has one or more carabineers 330, and/or other fasteners, molded therein.

### Conclusion

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A leash securing assembly, comprising:
(a) a retention device having an eye defined therethrough;
(b) a band member having first and second ends, said first end being secured to said retention device and said second end being adapted to be passed through said eye and then secured to a middle portion of said band member;
(c) a ring member coupled to said retention device; and
(d) a coupling member coupled to said ring member;
(e) wherein, said band member and said retention device are adapted to together define a generally elliptical loop.

2. The leash securing assembly of claim 1, wherein said retention device comprises a backing member having a retention member secured to it.

3-13. (canceled)

14. The leash securing assembly of claim 1, wherein said band member is releasably secured to said retention device.

15. The leash securing assembly of claim 1, wherein said band member is releasably secured to said retention device by a hook and loop fastener.

16-17. (canceled)

18. The leash securing assembly of claim 1, wherein said generally elliptical loop is adapted to receive an arm of a user, and said leash securing assembly is adapted to be secured about an upper portion of the arm of the user.

19. The leash securing assembly of claim 1, wherein said coupling device comprises:
(a) an elastic member having two ends; and
(b) coupling members secured to each end.

20. The leash securing assembly of claim 19, wherein a portion of each of said coupling members is embedded within the elastic member.

21. The leash securing assembly of claim 20, wherein said portion of each of said coupling members is molded within the elastic member.

22. The leash securing assembly of claim 19, wherein said coupling members comprise carabineers.

23. The leash securing assembly of claim 19, wherein the elastic member is injection molded.

24. The leash securing assembly of claim 19, wherein the elastic member is an elastomer.

25. The leash securing assembly of claim 19, wherein said elastic member is configured to break proximate a middle portion of said elastic member when tensioned.

26. The leash securing assembly of claim 19, wherein a first of said coupling members is coupled to said ring member.

27. The leash securing assembly of claim 26, wherein a leash is coupled to a second of said coupling members of said coupling device.

28. The leash securing assembly of claim 27, wherein the leash securing assembly is secured about an arm of a user.

29-46. (canceled)

47. A method of using a leash securing assembly, wherein
(a) said leash securing assembly comprises:
(i) a retention device having an eye defined therethrough,
(ii) a band member having first and second ends, said first end being secured to said retention device and said second end being adapted to be threaded through said eye and then secured to a middle portion of said band member,
(iii) a ring member coupled to said retention device, and
(iv) a coupling member coupled to said ring member;
(b) said band member and said retention device are adapted to together define a generally elliptical loop; and
(c) said method comprises:
(i) threading said second end of said band member through said eye, such that said generally elliptical loop is defined,
(ii) inserting an arm of a user into said elliptical loop and positioning said leash securing assembly about an upper portion of said arm of the user,
(iii) pulling said band member through said eye, thereby reducing a circumference of said generally elliptical loop, until said leash securing assembly is tight around said upper portion of said arm,
(iv) securing said band member to itself such that the circumference of said generally elliptical loop is generally fixed.

48. (canceled)

49. The method of claim 47, wherein said method further comprises coupling a leash to said coupling member.

50. The method of claim 49, wherein said method further comprises securing said leash to an animal.

51-53. (canceled)

54. A leash securing assembly comprising:
(a) an armband;
(b) a coupling device coupled to said armband, said coupling device comprising:
(i) an elastic member, and
(ii) a fastener embedded within said elastic member.

55. The coupling device of claim 54, wherein said elastic member is injection molded and is adapted to break proximate said middle portion when tensioned.

56-86. (canceled)
